(19) United States
(12) Patent Application Publication
(10) Pub. No.: US 2005/0067961 A1
(43) Pub. Date: Mar. 31, 2005

(54) Plasma display device and its driving method

(75) Inventor: Tadashi Nakamura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC PLASMA DISPLAY CORPORATION

(21) Appl. No.: 10/948,437

(22) Filed: Sep. 24, 2004

(30) Foreign Application Priority Data
Sep. 25, 2003 (JP) 2003-334438

(51) Int. Cl. H01J 17/49

(52) U.S. Cl. 313/582

(57) ABSTRACT

A plasma display panel (PDP) constituting a main part of a plasma display device has a front substrate and a back substrate disposed facing to the front substrate. A discharge gas space is formed between the front substrate and the back substrate. On the surface of the front substrate facing to the back substrate, a scanning electrode and a sustain electrode are disposed. Each of the scanning electrode and the sustain electrode has a transparent electrode made of conductive material and constituting a row electrode via a discharge gap,.and a bus electrode having a low resistance conductive material that is overlapped with a part of the transparent electrode to be electrically connected thereto. A priming electrode, parallel to each electrode, has a low resistance conductive material and is disposed between the scanning electrode of one display cell and the sustain electrode of other display cell adjacent to the one display cell.

### BACKGROUND OF THE INVENTION

1. Field of the Invention

The present invention relates to a plasma display device and its driving method. More particularly, the present invention relates to a plasma display device and its driving method such that a display period of a field of an image displayed by a plasma display panel (PDP) results from a combination of plural sub-fields for a gradation display.

2. Description of the Related Art

Typically, a plasma display device comprising the PDP as a main part has a number of advantages. The plasma display device is thinner, provides no flickers and has a greater display contrast ratio than a conventionally widely used display device such as a cathode ray tube (CRT) and a liquid crystal display device (LCD). Also, the plasma display device can have a relatively large screen, has a higher speed of response, and is a self-luminous type to be capable of emitting multi-colors by utilizing a phosphor material. In recent years, the plasma display device is getting widely used in the fields of a computer-related display device, a color image display and so on.

The plasma display device has two types depending on a driving mode; an AC discharge type where electrodes are covered with a dielectric layer and are driven indirectly under an AC discharged state, and a DC discharge type where electrodes are exposed to a discharge space and are driven under a DC discharged state. The DC discharge type plasma display device has a complex structure, since resistive elements are required in respective display cells in order to limit the discharged current. On the other hand, the AC discharge type plasma display device has a relatively simple structure, since no resistive elements are required due to wall electric charges formed on a dielectric layer that covers the electrodes. Accordingly, in recent years, the AC discharge type plasma display device is widely fabricated.

In particular, a three-electrode surface discharge type AC plasma display device is popular, since high energy ions that are produced upon a surface discharge do not impinge and not deteriorate a phosphor material formed on a back substrate, whereby it can be used for a prolonged time. The three-electrode surface discharge type AC plasma display device comprises a front (first) substrate on which a pair of row electrodes of a scanning electrode and a sustain (common) electrode in a horizontal (row) direction are disposed parallel to each other, a back (second) substrate on which a column electrode of a data (address) electrode is disposed orthogonal to the row electrodes in a vertical (column) direction, and display cells (simply referred to as cells) disposed at intersections of the row electrodes and the column electrode. The three-electrode surface discharge type AC plasma display device displays images by driving the scanning electrode and the data electrode to induce an opposed discharge, inducing a writing discharge (i.e., address selection) for selecting cells to be emitted light, and then driving the scanning electrode and the common electrode to induce a sustain discharge due to the surface discharge in the cells selected.

FIG. 1 is a perspective view showing a schematic structure of a PDP constituting a main part of a conventional three-electrode surface discharge type AC plasma display device (hereinafter referred to as “plasma display device”). FIG. 2 is a C-C cross sectional view of FIG. 1. FIG. 3 is a block diagram showing a schematic structure of the plasma display device using the PDP of FIG. 1. FIG. 4 is driving wave forms used in a method of driving the plasma display device. FIG. 5 is a sectional view of the plasma display device when visible light is generated upon a preliminary discharge. As shown in FIGS. 1 and 2, the PDP 100 comprises a front (first) substrate 101, a back (second) substrate 102 disposed facing to the substrate 101, and a discharge gas space 103 formed between the substrates 101 and 102.

The front substrate 101 comprises a first insulation substrate 104, a scanning electrode 105 and a sustain electrode 106, a pair of a bus electrode 105A for the scanning electrode and a bus electrode 106A for the sustain electrode, a dielectric layer 108, and a protective layer 109. The first insulation substrate 104 is made of a transparent insulation material such as glass. The scanning electrode 105 and the sustain electrode 106 are made of a transparent conductive material that are disposed parallel each other via a discharge gap 107 (surface discharge gap) on an inner surface of the first insulation substrate 104 in a row direction H to constitute a pair of row electrodes. The bus electrode 105A for the scanning electrode and the bus electrode 106A for the sustain electrode are made of low resistance conductive material that are overlapped with the parts of the scanning electrode 105 and the sustain electrode 106 respectively. The dielectric layer 108 covers the scanning electrode 105 including the bus electrode 105A and the sustain electrode 106 including the bus electrode 106A. The protective layer 109 protects the dielectric layer 108 from being charged.

On the other hand, the back substrate 102 comprises a second insulation substrate 111, a data (address) electrode 112, a dielectric layer 113, partition walls 114, and a phosphor layer 115. The second insulation substrate 111 is made of a transparent insulation material such as glass. The data (address) electrode 112 is formed on an inner surface of the second insulation substrate 111 in a column direction V orthogonal to the row direction H to constitute a column electrode. The dielectric layer 113 covers the data electrode 112. The partition walls 114 provide the discharge spaces 103 containing a discharge gas of He (helium), Ne (neon) or Xe(xenon) etc. or mixture thereof and are formed in the column direction V to partition respective display cells. The phosphor layer 115 comprises a red phosphor layer, a green phosphor layer and a blue phosphor layer that covers a bottom surface and internal walls of the partition walls 114. A plurality of display cells are disposed in a matrix along the row direction H and the column direction V. Thus, a PDP 100 is constructed.

Now, referring to FIGS. 1 and 2, a basic operation of the display cells selected in the PDP 100 will be described. In each display cell, a pulse voltage exceeding a discharge threshold value is applied between the scanning electrode 105 and the data electrode 112 to start a discharge. Depending on the polarity of the pulse voltage, positive or negative charges are attracted to the surface of the dielectric layer 108 or 113 and the charge is accumulated. An equivalent inner voltage, i.e., a wall voltage resulting from the charge accumulation has the opposite polarity of the pulse voltage. An effective voltage within the cell is decreased as the discharge is increased. The discharge cannot be maintained and is finally stopped, even if the pulse voltage keeps the constant value.

When the discharge is generated between the scanning electrode 105 and the data electrode 112, the voltage at a predetermined level or more is applied between the scanning electrode 105 and the sustain electrode 106. The discharge becomes a trigger to generate discharge between the scanning electrode 105 and the sustain electrode 106. Similar to the discharge generated between the scanning electrode 105 and the data electrode 112, a charge is accumulated on the dielectric layer 108 so that the voltage applied is canceled. Then, when a sustain discharge pulse that has the same polarity of the wall voltage is applied between the scanning electrode 105 and the sustain electrode 106, the wall voltage is superimposed as an effective voltage, whereby discharge can be superimposed exceeding the discharge threshold value, if a voltage amplitude of the sustain discharge pulse is low. When the sustain discharge is generated, the charge is again accumulated on the dielectric layer 108 so that the voltage applied is canceled. The polarity of the wall charges is opposite before the sustain discharge is generated. Accordingly, the sustain discharge pulse is continuously applied between the scanning electrode 105 and the sustain electrode 106 by inverting the polarity, thereby maintaining the discharge. This is called as a memory function.

When the discharge is generated within the display cell, the discharge gas entered into the discharge gas space 103 generates ultraviolet rays. When the phosphor layer 115 is irradiated with the ultraviolet rays, the layer 115 is excited to generate visible rays 116. The visible rays 116 are radiated through a front surface via the scanning electrode 105 and the sustain electrode 106 each of which is made of the transparent insulation material. Wavelengths of the visible rays 116 are determined by the material of the phosphor layer 115. In order to provide a full-color display, the phosphor layer that emits light in three primary colors, i.e., red, green and blue may be used.

Referring to FIG. 3, a schematic structure of a plasma display device including the PDP 100 as a main part will be described. The PDP 100 is a display panel having display cells 117 disposed in a matrix on intersections of m rows x n columns. The PDP 190 comprises as row electrodes scanning electrodes 105 (X1, X2, . . . , Xm) and sustain electrodes 106 (Y1, Y2, . . . , Ym) that are disposed parallel each other, and as column electrodes data electrodes 112 (D1, D2, . . . , Dn) that disposed orthogonal to the scanning electrodes 105 and the sustain electrodes 106. A scanning electrode driving waveform produced on a scanning driver 118 is applied to the scanning electrode 105. A sustain electrode driving waveform produced on a sustain driver 119 is applied to the sustain electrode 106. A data electrode driving waveform produced on a data driver 120 is applied to the data electrode 112. Control signals of respective drivers 118 to 120 are produced on a driver control circuit 121 based on a basic signal (Vsync (vertical synchronizing signal), Rsync (horizontal synchronizing signal), Clock (clock signal) and DATA (data signal)).

Referring to FIG. 4, a driving method of the plasma display device shown in FIG. 3 will be described. FIG. 4 shows a sustain electrode driving waveform Wu commonly applied to the sustain electrodes (Y1, Y2, . . . , Ym), scanning electrode driving waveforms Ws1, Ws2, . . . , Wsm respectively applied to the scanning electrodes (X1, X2, Xm), and a data electrode driving waveform Wd applied to the data electrode (Di) (1≦i ≦n). A period of driving (1 sub-field: 1 SF) is constituted by a preliminary discharge period T1, a writing discharge period T2, a sustain discharge period T3 and an erase discharge period T4. Plural SFs are repeated to assemble a display period in one field (1F), thereby providing a desired image display screen.

The preliminary discharge period T1 is for producing active particles and wall charges within the discharge gas space 103 in order to provide stable writing discharge properties during the writing discharge period T2 later. After a preliminary discharge pulse Pp that simultaneously discharges all display cells in the PDP 100 is applied, a preliminary discharge erase pulse Ppe for erasing the charges that exclude the writing discharge and the sustain discharge of the wall charges produced is applied to respective scanning electrodes (X1, X2, . . . , Xm) at once. In other words, the preliminary discharge pulse Pp having a potential that increases slowly against the scanning electrodes (X1, X2, . . . , Xm) is applied to discharge all display cells. Then, voltages of the sustain electrodes (Y1, Y2, . . . , Ym) are increased to a sustain voltage Vs level, and the preliminary discharge erase pulse Ppe is applied to the scanning electrodes (X1, X2, . . . , Xm) to decrease slowly their potentials. An erase discharge is generated to erase the wall charges accumulated by the preliminary discharge pluses. The erase herein means that not only all wall charges are erased, but also the wall charges are controlled so that the subsequent writing discharge and the sustain discharge are smoothly conducted.

During the wiring discharge period T2, a common scanning base pulse Pwb is applied to the scanning electrodes (X1, X2, . . . , Xm), a scanning pulse Pw is sequentially applied to the scanning electrodes (X1, X2, . . . , Xm) based on the potentials of the scanning base pulse Pwb, a data pulse Pd that synchronizes the scanning pulse Pw is selectively applied to the data electrode (Di) (1≦i≦n) of the display cells to be displayed, and the writing discharges are generated in the cells to be displayed to produce the wall charges. The scanning base pulse Pwb may be set to have the voltage that the discharge is not generated in combination with the data pulse Pd. Using the setting, the scanning pulse Pw can have narrower amplitudes. As a result, the scanning driver 118 having a low withstand voltage can be used in the PDP 100 shown in FIG. 3.

During the sustain discharge period T3, a sustain discharge pulse Pc is applied to a sustain electrode Wu, a sustain discharge pulse Ps whose phase lags behind the sustain discharge pulse PC by 180° is applied to the respective scanning electrodes (X1, X2, . . . , Xm), and the display cells that are subjected to the writing discharge in the writing discharge period T2 are subjected repeatedly to the sustain discharge to provide the desired brightness.

Finally, during the erase discharge period T4, an erase pulse Pe is applied to the scanning electrodes (X1, X2, . . . , Xm) to slowly decrease their potentials, whereby erase discharge is generated to erase the wall charges accumulated on the sustain pulse Ps. The erase herein means that not only all wall charges are erased, but also the wall charges are controlled so that the subsequent writing discharge and the sustain discharge are smoothly conducted.

A plurality of SFs having the above-mentioned constitutions construct one field (1F). A combination of the SFs selected make it possible to display a gradation. For example, 1F is constituted by eight SFs, and sustain discharge times are controlled so that proportions (weighting) of brightnesses provided by the respective sustain discharges in the SFS are 1, 2, 4, 8, 16, 32, 64, and 128. The brightness of 1F is the sum of the brightnesses of the SFs which are selected. By changing the combination of the SFs selected, 256-gradations, i.e., from 0 to 255 brightness levels, can be attained.

In the conventional plasma display device constituted by the PDP having many SFs in one field, background brightness is strengthened also in the cells during the writing discharge period T2 and in the cells which are during the sustain discharge period T3 but not addressed in the preceding writing discharge period, both of which should display a black. As a result, those cells display a white slightly. Therefore, the contrast between the brightnesses of the display area and the non-display area of the PDP is decreased to unfavorably decrease clearness of the images. This is because the preliminary discharge period exist in each SF. The preliminary discharge generates discharge in all display cells, regardless of the selection of the SF. The visible light caused by the discharge constitute background brightness. Consequently, the more the SFs are, the more the background brightness increases.

The visible light generated upon the preliminary discharge in the conventional plasma display device as described above is shown in FIG. 5. Since the potential of the preliminary discharge pulse Pp used in the driving waveform shown in FIG. 4 is slowly increased, the wall charges are accumulated under the state that the voltage that is a little greater than the discharge threshold value is applied at the same time, even if the discharge is generated once the voltage exceeds the discharge threshold value. The effective voltage that contributes to the discharge continuously generated by the preliminary discharge pulse Pp is the voltage that the wall charges accumulated immediately before are subtracted from the reached voltage of the preliminary discharge pulse Pp. The effective voltage does not become so great, and therefore has discharge strength lower than that of the discharge at the sustain discharge pulse Ps that applies the voltage which is steeply changed. The discharge is small and does not reach the bus electrodes 105A and 106A that are distant from the discharge gap 107 between the scanning electrode 105 and the sustain electrode 106.

Japanese Unexamined Patent Application Publication No. 8-96714 discloses a PDP and its driving method that the background brightness is decreased to improve the contrast. FIG. 6 is a sectional view showing a schematic structure of such PDP. FIG. 7 shows a driving waveform used in the driving method of the PDP. FIG. 8 shows visible light generated upon the preliminary discharge in the driving method of the PDP. As shown in FIG. 6, the PDP 100 comprises a priming electrode 130 disposed between the scanning electrodes 105 or between the sustain electrodes 106. Priming discharge is generated between the priming electrode 130 and the scanning electrode 105 or between the priming electrode 130 and the sustain electrode 106. The priming electrode 130 is formed between the scanning electrodes 105 on adjacent scanning lines as shown in FIG. 6. The partition walls 114 that partition the display cells are formed between the scanning lines. The rests of the components are similar as shown in FIG. 2. The components with the same reference numbers as indicated in FIG. 6 refer the same components shown in FIG. 2, and the same descriptions are not repeated.

Referring to FIG. 7, the driving method of the PDP will be described. After the erase pulse Pe is applied, the priming pulse Pp is applied to the priming electrode 130. Priming discharge is generated between the priming electrode 130 and the scanning electrode 105. After the priming discharge is generated, the preliminary discharge erase pulse Ppe is applied to the scanning electrode 105. The wall charges accumulated by the preliminary discharge pluses on the protective layer 109 are discharged into the discharge gas space 103 to erase the wall charges. Then, common sustain discharge is generated on line sequential scanning and all scan electrodes 105. After the priming erase pulse Ppe is removed, a cancel pulse Pwc is applied to the priming electrode 130. The voltage of the cancel pulse Pwc has a value that no discharge is generated between the priming electrode 130 and the scanning electrode 105 caused by the scanning pulse Pw applied to the scanning electrode 105. The cancel pulse Pwc is stopped after the scanning period is terminated.

When the sustain pulse Pc and the erase pulse Ppe are applied, the priming electrode 130 is in a float state. The float state is maintained after the application of the sustain pulse Pc is terminated until the application of the erase pulse Pe in the next SP is terminated. Using the prior art, the priming discharge does not reach the all display cells. Since the priming electrode 130 is made of an opaque conductive material, a percentage that light generation of the priming discharge is radiated to a display side is decreased.

In the conventional PDP and its driving method disclosed in Japanese unexamined Patent Application Publication No. 8-96714, priming brightness provided by the priming discharge is not sufficiently lowered. The background brightness is not yet lowered and it cannot prevent the contrast from lowering.

In the prior art as disclosed in Japanese unexamined Patent Application Publication No. 8-96714, the priming discharge is generated between the priming electrode 130 and the scanning electrode 105, and the voltage applied by the illustrative priming pulse Pp is changed steeply, as shown in FIG. 8. The priming discharge is generated throughout the area from the priming electrode 130 to the scanning electrode 105 other than the partition walls 114. The bus electrode 105A and the priming electrode 130 are made of the opaque conductive material. The light produced by the discharge is shielded by the electrodes 105A and 130. The visible light 116 is emitted from an area where the scanning electrode 105 and the bus electrode 105A are not overlapped, and the space between the scanning electrode 105 and the priming electrode 130, as shown in FIG. 8. However, the area of the scanning electrode 105 made of the transparent conductive material is considerably greater than that of the bus electrode 105A. As a result, the quantity of the visible light 116 produced by the priming discharge becomes high, and the priming brightness above-described cannot be sufficiently decreased. Consequently, because the background brightness is not decreased, the contrast cannot be prevented from lowering.

### SUMMARY OF THE INVENTION

Accordingly, it is an object of the present invention to provide a plasma display device and its driving method that the background brightness in the priming discharge is decreased and the contrast is prevented from lowering.

On aspect of the present invention is a plasma display device, comprising: plural pairs of surface discharge electrodes each having a long scanning electrode and a sustain electrode that are extended in a predetermined direction and disposed parallel each other via a discharge gap, and priming electrodes disposed between the surface discharge electrodes. The scanning electrode and the sustain electrode each has a transparent electrode facing to the discharge gap and a bus electrode having lower light transmittance than that of the transparent electrode. The bus electrode is electrically connected to the transparent electrode by a connection part. A surface discharge is controlled such that the surface discharge generated between the transparent electrode of the scanning electrode and the transparent electrode of the sustain electrode extends to both of the bus electrodes over the gap between the transparent electrode and the bus electrode. However, a preliminary discharge generated between the priming electrode and the bus electrode of the scanning electrode or between the priming electrode and the bus electrode of the sustain electrode is controlled such that the preliminary discharge does not extend to the transparent electrode of the scanning electrode or the transparent electrode of the sustain electrode over the gap adjacent to each of the bus electrode.

The plasma display device according to the present invention may further comprise a light-shielding layer that covers at least the gap between the transparent electrode and the bus electrode.

According to the plasma display device of the present invention, the light-shielding layer may cover at least a gap between the priming electrode and the transparent electrode of the scanning electrode or the sustain electrode that is paired with the priming electrode.

Another aspect of the present invention is a method of driving a plasma display device comprising plural pairs of surface discharge electrodes each having a long scanning electrode and a sustain electrode that are extended in a predetermined direction and disposed parallel each other via a discharge gap, and priming electrodes disposed between the surface discharge electrodes. Said driving method comprises the steps of: discharging (first preliminary discharging) simultaneously entire display cells between the priming electrode and the scanning electrode or the sustain electrode adjacent to the priming electrode, and discharging (second preliminary discharging) sequentially the entire display cells after said first preliminary discharging.

According to the method of driving a plasma display device of the present invention, the scanning electrode and the sustain electrode each may have a transparent electrode facing to the discharge gap, a bus electrode having lower light transmittance than that of the transparent electrode, and a connection part electrically connecting the bus electrode and the transparent electrode. A surface discharge generated between the transparent electrode of the scanning electrode and the transparent electrode of the sustain electrode extends to the bus electrodes over the gaps between the transparent electrode and the bus electrode, but such that the first and the second preliminary discharges generated between the priming electrode and the bus electrode of the scanning electrode and between the priming electrode and the bus electrode of the sustain electrode does not extend to the transparent electrodes of the scanning electrode and the sustain electrode over the gap adjacent to the bus electrode.

According to the method of driving a plasma display device of the present invention, the second preliminary discharging may be performed between the priming electrode and the scanning electrode or the sustain electrode adjacent to the priming electrode that is not subjected to the first preliminary discharging.

According to the method of driving a plasma display device of the present invention, the first preliminary discharging may be performed at a driving pulse with a gradually changing potential.

According to the method of driving a plasma display device of the present invention, in the step of second preliminary discharging, the entire display cell may be sequentially discharged in each scanning line.

According to the method of driving a plasma display device of the present invention, in the step of second preliminary discharging, the priming electrode may be applied to a priming bias pulse.

According to the plasma display device and its diving method of the present invention, a preliminary discharge generation area is decreased, and the quantity of the visible light which is produced upon the preliminary discharge and reaches the display surface is decreased by the shielding layer. Advantageously, the background brightness is decreased and image quality with high contrast can be achieved. Also, the time from the preliminary discharge start to the writing discharge is shortened, whereby a discharge lag time upon writing can be shortened and a time required for the writing discharge can also be shortened. As the writing discharge time is decreased, the sustain discharge time can be increased to improve the display brightness, and the numbers of the sub-fields are increased to increase the gradation numbers.

### BRIEF DESCRIPTION OF THE DRAWINGS

FIG. 1 is a perspective view showing a schematic structure of a PDP constituting a main part of a conventional plasma display device;

FIG. 2 is a C-C cross sectional view of FIG. 1;

FIG. 3 is a block diagram showing a schematic structure of the plasma display device using the PDP of FIG. 1;

FIG. 4 is driving wave forms used in a method of driving the plasma display device;

FIG. 5 is a sectional view of the plasma display device when visible light is generated upon a preliminary discharge;

FIG. 6 is a sectional view showing a schematic structure of a PDP constituting a main part of a conventional plasma display device;

FIG. 7 shows a driving waveform used in the driving method of the plasma display device;

FIG. 8 shows visible light generated upon the preliminary discharge in the driving method of the plasma display device;

FIG. 9 is a perspective view showing a schematic structure of a PDP constituting a main part of a plasma display device according to a first embodiment of the present invention;

FIG. 10 is a A-A cross sectional view of FIG. 9;

FIG. 11 is a sectional view of the plasma display device when visible light is generated upon a preliminary discharge;

FIG. 12 is a sectional view showing a schematic structure of a PDP constituting a main part of a plasma display device according to a second embodiment of the present invention;

FIG. 13 is driving wave forms used in a first method of driving the plasma display devices of the first and second embodiment;

FIGS. 14A to 14F are sectional views of the plasma display device showing actions from the preliminary discharge period to the erase discharge period in the first driving method, FIG. 14A is a sectional view of the plasma display device when the preliminary discharge pulse Pp is applied, FIG. 14B is a sectional view of the plasma display device when the preliminary discharge erase pulse Ppe is applied, FIG. 14C is a sectional view of the plasma display device when the scanning pulse Pw and the data pulse Pd are applied, FIG. 14D is a sectional view of the plasma display device when the potential of the sustain electrode 6 is in GND level during the sustain discharge period T3 and the potential of the scanning electrode 5 is in the sustain voltage Vs level, FIG. 14E is a sectional view of the plasma display device when the potential of the sustain electrode 6 is in the sustain voltage Vs level during the sustain discharge period T3 and the potential of the scanning electrode 5 is in GND level, and FIG. 14F is a sectional view of the plasma display device when the erase pulse Pe is applied;

FIG. 15 a block diagram showing a schematic structure of the plasma display device of the first or second embodiment;

FIG. 16 is driving wave forms used in a method of driving the plasma display device of the first or second embodiment;

FIGS. 17A to 17F are sectional views of the plasma display device showing actions from the preliminary discharge period to the erase discharge period in the second driving method, FIG. 17A is a sectional view of the plasma display device when the preliminary discharge pulse Pp is applied, FIG. 17B is a sectional view of the plasma display device when the preliminary discharge erase pulse Ppe is applied, FIG. 17C is a sectional view of the plasma display device when the scanning pulse Pw and the data pulse Pd are applied, FIG. 17D is a sectional view of the plasma display device when the potential of the sustain electrode 6 is in GND level during the sustain discharge period T3 and the potential of the scanning electrode 5 is in the sustain voltage Vs level, FIG. 17E is a sectional view of the plasma display device when the potential of the sustain electrode 6 is in the sustain voltage Vs level during the sustain discharge period T3 and the potential of the scanning electrode 5 is in GND level, and FIG. 17F is a sectional view of the plasma display device when the erase pulse Pe is applied;

FIG. 18 is a sectional view showing a schematic structure of a PDP constituting a main part of a plasma display device according to a third embodiment of the present invention;

FIG. 19 is a sectional view showing a schematic structure of a PDP constituting a main part of a plasma display device according to a fourth embodiment of the present invention;

FIG. 20 is a B-B cross sectional view of FIG. 19;

FIG. 21 is a sectional view showing a schematic structure of a PDP constituting a main part of a plasma display device according to a fifth embodiment of the present invention;

FIG. 22 is a sectional view showing a schematic structure of a PDF constituting a main part of a plasma display device according to a sixth embodiment of the present invention;

FIG. 23 is driving wave forms used in a first method of driving the plasma display device of the sixth embodiment;

FIG. 24 is a block diagram showing a schematic structure of the plasma display device of the sixth embodiment;

FIG. 25 is driving wave forms used in a second method of driving the plasma display device of the sixth embodiment;

FIG. 26 is a sectional view showing a schematic structure of a PDP constituting a main part of a plasma display device according to a seventh embodiment of the present invention;

FIG. 27 is driving wave forms used in a method of driving the plasma display device of the seventh embodiment; and

FIG. 28 is a block diagram showing a schematic structure of the plasma display device of the eighth embodiment.

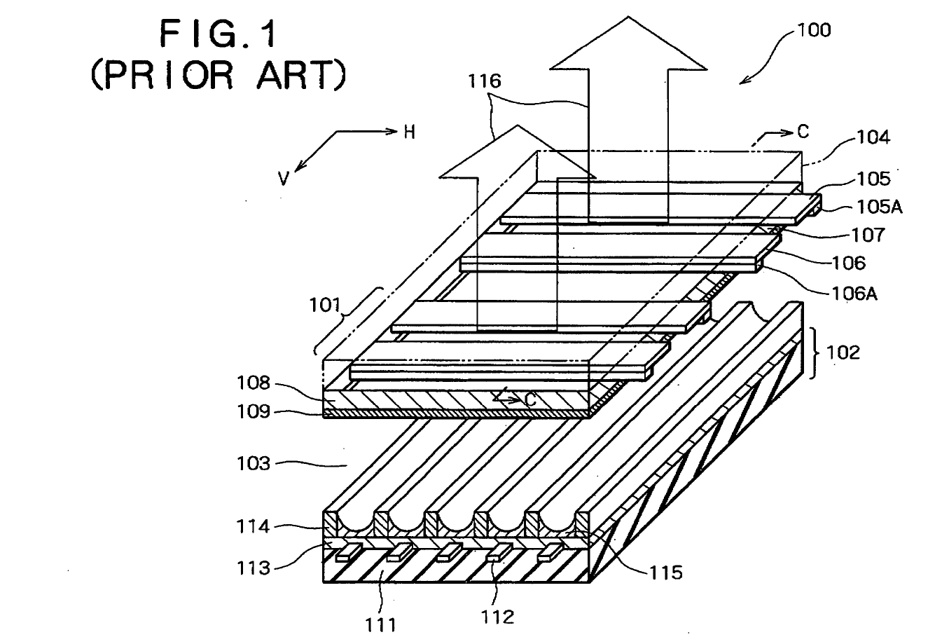

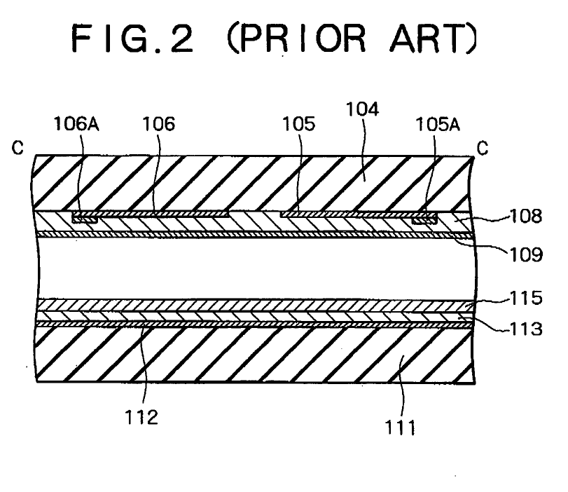

### DETAILED DESCRIPTION OF THE PREFERRED EMBODIMENTS

Embodiments of the invention will now be described by way of example with reference to the following detailed description and accompanying drawings.

The PDP comprises a front substrate and a back substrate disposed facing to the front substrate. A discharge gas space is formed between the front substrate and the back substrate. On the surface of the front substrate facing to the back substrate, a scanning electrode and a sustain electrode, a pair of bus electrodes and a priming electrode are provided. The scanning electrode and the sustain electrode are formed of a transparent conductive material and are opposed to each other via a discharge gap to constitute row electrodes. The bus electrodes which are formed of a low resistance conductive material are overlapped with the scanning electrode and the sustain electrode to be electrically connected thereto, respectively. The priming electrode is made of a low resistance conductive material and is disposed parallel to said bus electrode and between the scanning electrode of one display cell and the sustain electrode of other display cell adjacent to said one cell.

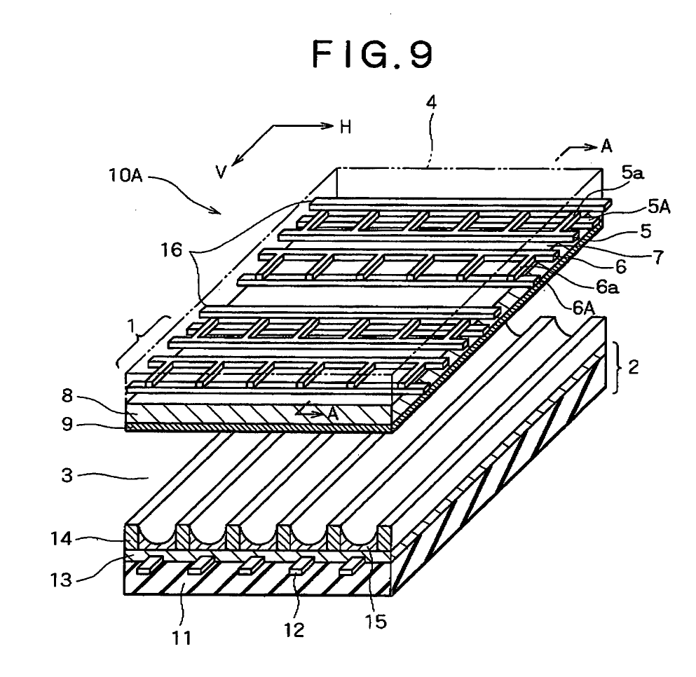

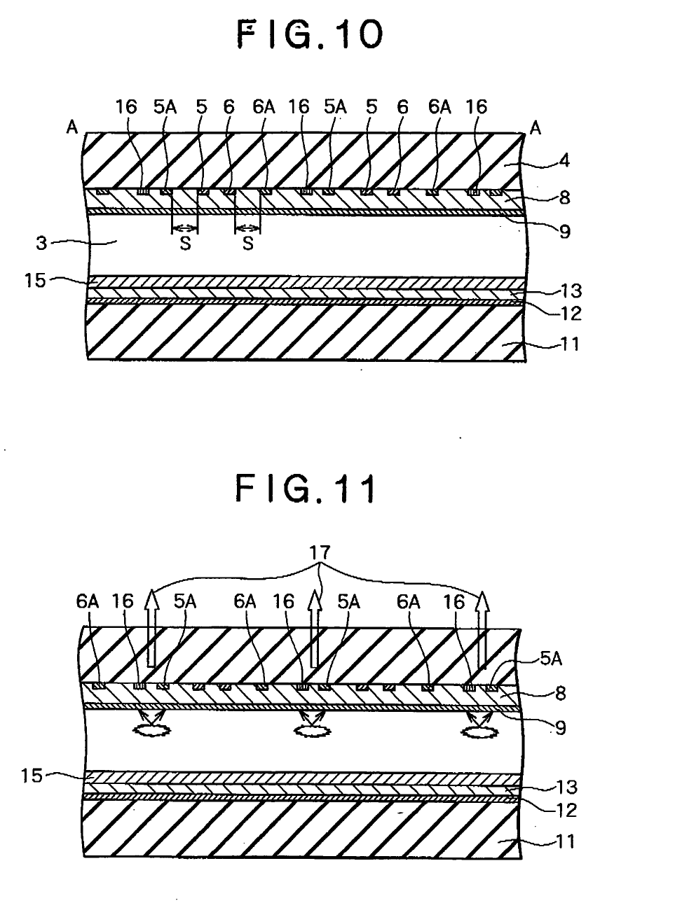

A first embodiment of the present invention will be described. FIG. 9 is a perspective view showing a schematic structure of the PDP constituting the main part of the plasma display device according to the first embodiment of the present invention. FIG. 10 is a A-A cross sectional view of FIG. 9. FIG. 11 is a sectional view of the plasma display device when visible light is generated upon a preliminary discharge.

As shown in FIGS. 9 and 10, a PDP 10A comprises a front (first) substrate 1, a back (second) substrate 2 disposed facing to the substrate 1, and a discharge gas space 3 formed between the substrates 1 and 2.

The front substrate 1 has a first insulation substrate 4, a scanning electrode 5, a sustain electrode 6, a bus electrode 5A for the scanning electrode, a bus electrode 6A for the sustain electrode, a priming electrode 16, a dielectric layer 8, and a protective layer 9. The first insulation substrate 4 is made of a transparent insulation material such as soda lime glass and so on. The scanning electrode 5 and the sustain electrode 6 are formed on an inner surface of the first insulation substrate 4 in a row direction a via a discharge gap (surface discharge gap) 7 to constitutes a pair of row electrodes, and are made of a transparent conductive material such as indium tin oxide (ITO), tin oxide (SnO₂) and so on. The bus electrode 5A for the scanning electrode and the bus electrode 6A for the sustain electrode are respectively formed and overlapped on/with the parts of the scanning electrode 5 and the sustain electrode 6, are electrically connected, and made of a low resistance conductive material such as aluminum (Al), copper (Cu) and silver (Ag). The priming electrode 16 is disposed between the scanning electrode 5 for one display cell and the sustain electrode 6 for other display cell adjacent to the one display cell so as to be parallel to the scanning electrode 5 and the sustain electrode 6, and made of Al, Cu, Ag and the like. The dielectric layer 8 covers the scanning electrode 5 including the bus electrode 5A and the sustain electrode 6 including the bus electrode 6A, and is made of frit glass including zinc, frit glass including lead and the like. The protective layer 9 protects the dielectric layer 8 from discharging, and is made of magnesium oxide (MgO) and the like.

The scanning electrode 5 and the sustain electrode 6 have connection (overhanging) parts 5a and 6a, respectively. The connection parts 5a and 6a are partly overlapped with the bus electrodes 5A and 6A respectively, and are disposed on partition walls 14 described later. A space S separates the scanning electrode 5 and the sustain electrode 6 excluding the connection parts 5a and 6a from the bus electrodes 5A and 6A, respectively. The bus electrodes 5A and 6A are disposed facing to the priming electrode 16.

On the other hand, the back substrate 102 comprises a second insulation substrate 11 made of a transparent insulation material such as soda lime glass, a data (address) electrode 12 made of Al, Cu, Ag and the like that is formed on an inner surface of the second insulation substrate 11 in a column direction V orthogonal to the row direction H to constitute a column electrode, a dielectric layer 13 made of frit glass including zinc, frit glass including lead and the like that covers the data electrode 12, partition wall 14 made of frit glass including lead and the like that provide the discharge gas space 3 containing a discharge gas alone or in combination, i.e., He, Ne and Xe and that are formed in the column direction V to partition respective display cells, and a fluorescent layer 15 comprising a red phosphor layer, a green phosphor layer and a blue phosphor layer that covers a bottom surface and internal walls of the partition walls 14.

One display cell includes three electrodes: the scanning electrode 5, the sustain electrode 6 and the data electrode 12. In a PDP of a monochrome plasma display device, one display cell constitutes one pixel in a display. In a PDP 10A of a color plasma display device, three display cells respectively including a red phosphor layer, a green phosphor layer and a blue phosphor layer constitute one pixel of a display. A plurality of pixels are disposed in a matrix along the row direction H and the column direction V.

In the above-mentioned PDP 10A, the preliminary discharge is performed between the priming electrode 16 and the bus electrode 5A of the scanning electrode 5 facing to the priming electrode 16. Upon the preliminary discharge, visible light 17 is generated between the priming electrode 16 and the bus electrode 5A, and is not generated on the scanning electrode 5. AS show in FIG. 9, the scanning electrode 5 and the bus electrode 5A are electrically connected and act always at the same voltage. On the other hand, as shown in FIG. 10, the space S separates the scanning electrode 5 excluding the connection parts 5a from the bus electrode 5A. Therefore, the discharge between the priming electrode 16 and the bus electrode 5A does not spread to the scanning electrode 5. This is because the preliminary discharge is started at the portion (discharge gap) where the distance between the priming electrode 16 and the bus electrode 5A is the shortest and the voltage at which the discharge is started tends to decrease when the discharge gap is small. The discharge start voltage at which the discharge is started has a characteristic curve wherein the discharge start voltage is increased when the discharge gap becomes extremely small. However, in a surface discharge structure where the scanning electrode 5 and the sustain electrode 6 are formed in a direction apart from the discharge gap, the priming discharge is still started around the discharge gap. The driving method in this embodiment will be summarized in the second embodiment described later for convenience.

Once the priming discharge is generated, it grows up in a direction apart from the discharge gap along the bus electrode 5A facing to the discharge space. However, in this embodiment, the electrode for promoting the growth of the discharge in the direction toward the scanning electrode 5 is not exist between the bus electrode 5A and the scanning electrode 5, and the growth is stopped there. This is the reason why the preliminary discharge is not spread to the scanning electrode 5. Accordingly, the preliminary discharge is generated only from the priming electrode 16 to the bus electrode 5A. The visible light generated by the preliminary discharge is emitted from the space between the priming electrode 16 and the bus electrode 5A both of which are made of the opaque conductive material such as Al, Cu and Ag. As a result, the priming brightness can be significantly decreased as compared with the prior art. In this embodiment, the space S is also disposed between the sustain electrode 6 and the bus electrode 6A. If the sustain discharge is performed between the scanning electrode 5 and the sustain electrode 6 having asymmetric shapes viewed from the center of the gap (sustain discharge gap) between the scanning electrode 5 and the sustain electrode 6, the sustain discharge is affected by the asymmetry. The light produced by the sustain discharge may be biased on either electrode.

In the PDP 10A constituting the main part of the plasma display device in this embodiment, the priming electrode 16 made of the opaque conductive material and the scanning electrode 5 made of the transparent conductive material are disposed parallel each other and the space S separates the scanning electrode 5 excluding the connection parts 5a from the bus electrode 5A. The priming discharge between the priming electrode 16 and the bus electrode 5A does not reach the scanning electrode 5, whereby the priming brightness provided by the priming discharge is sufficiently lowered.

Thus, the background brightness in the priming discharge can be decreased and the contrast can be prevented from lowering.

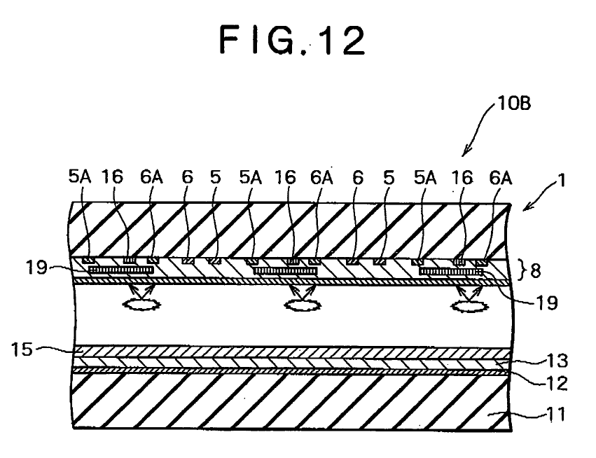

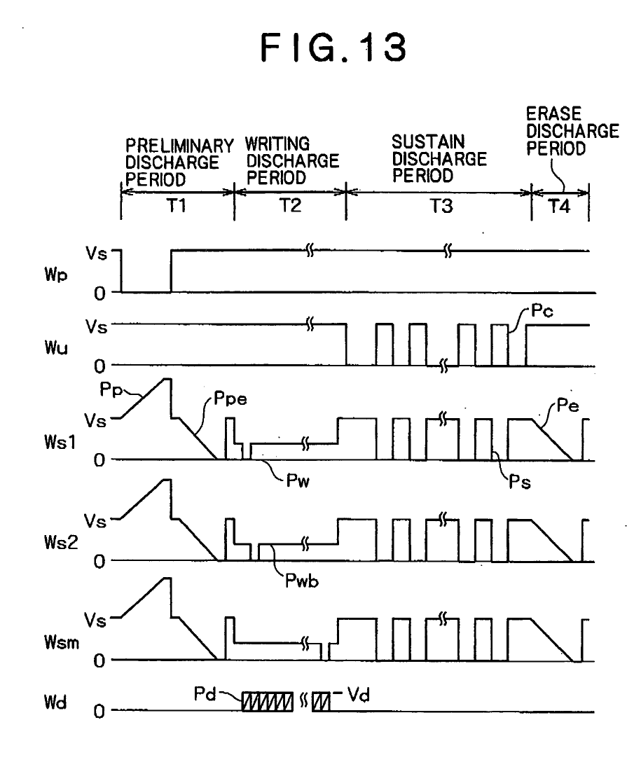

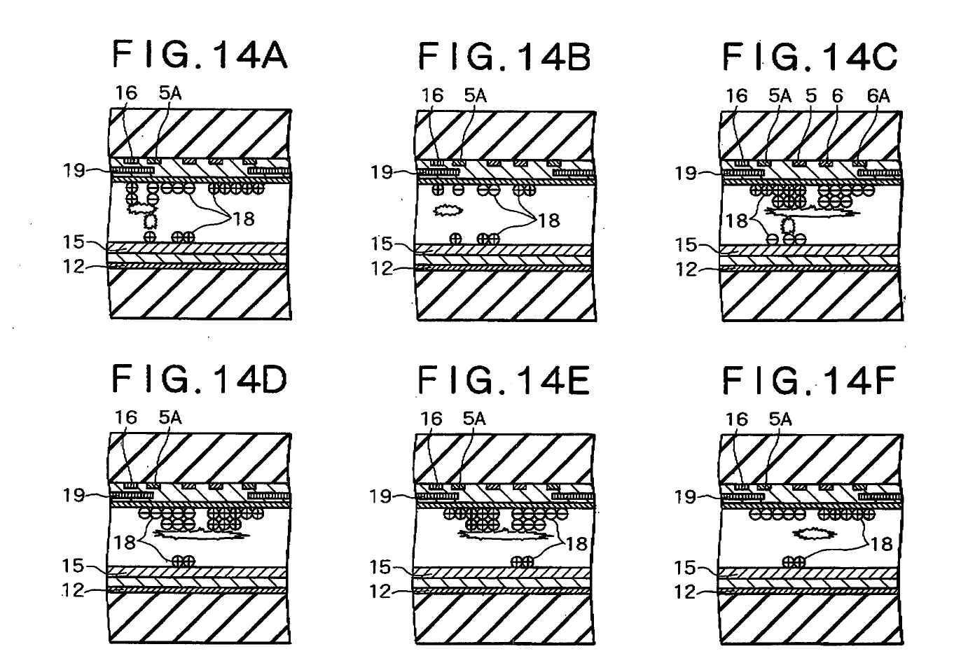

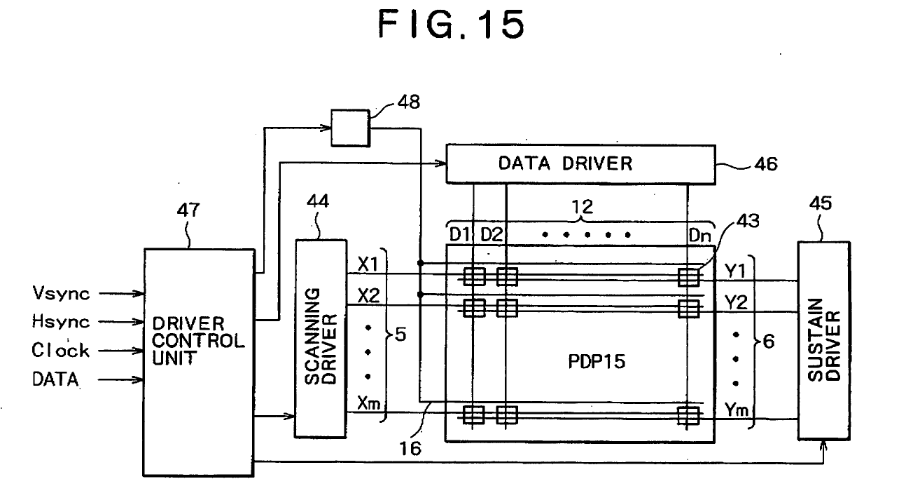

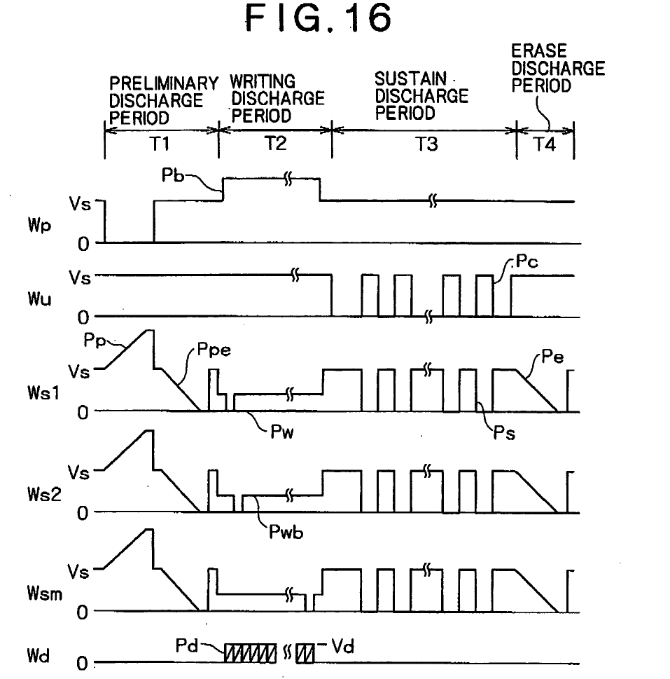

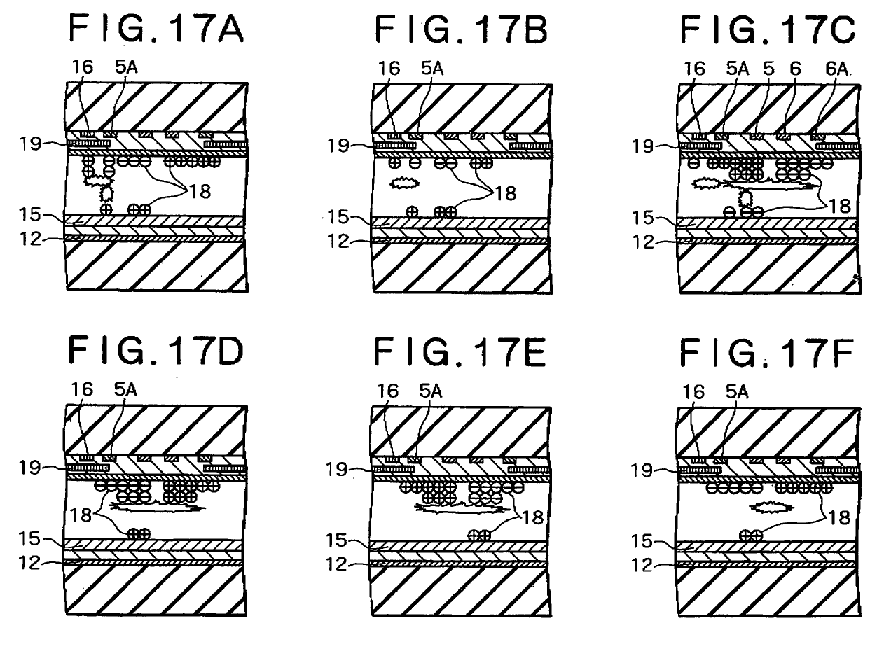

A second embodiment of the present invention will be described. FIG. 12 is a sectional view showing a schematic structure of a PDP constituting a main part of a plasma display device according to a second embodiment of the present invention. FIG. 13 shows waveforms of the driving signals in a first method of driving the plasma display devices of the first and second embodiment. FIGS. 14A to 14F are sectional views of the plasma display device showing actions from the preliminary discharge period to the erase discharge period in the first driving method. FIG. 15 a block diagram showing a schematic structure of the plasma display device of the first or second embodiment. FIG. 16 shows waveforms of the driving signals in a method of driving the plasma display device of the first or second embodiment. FIGS. 17A to 17F are sectional views of the plasma display device showing actions from the preliminary discharge period to the erase discharge period in the second driving method. The PDP constituting the main part of the plasma display device in this embodiment has a structure different from the first embodiment in that the light-shielding layer is formed in the dielectric layer of the front substrate.

As shown in FIG. 12, in a PDP 10B constituting a main part of a plasma display device in this embodiment, a light-shielding layer 19 is formed in the dielectric layer 8 of the front substrate 1, and is disposed parallel to the scanning electrode 5, the sustain electrode 6 and the priming electrode 16 to cover the priming electrode 16 and the bus electrodes 5A and 6A. The light-shielding layer 19 has a width that covers the space between the bus electrodes 5A and 6A of the adjacent display cells. The rests of the components are similar to the structure of the first embodiment. The components with the same reference numbers as indicated in FIG. 12 refer the same components shown in FIGS. 10 and 11, and the same descriptions are not repeated.

In this embodiment, the discharge is generated upon the preliminary discharge of a plasma display layer in the PDP 10B, as shown in FIG. 12. The light-shielding layer 19 is disposed so that the whole area where visible light is generated by the preliminary discharge is covered, whereby the light produced in the first embodiment is shielded, and almost all the light produced by preliminary discharge can be excluded on the display side. In order only to exclude the light produced by the preliminary discharge, the light-shielding layer 19 may be disposed to cover at least the discharge gap 7 upon the priming discharge. However, the light-shielding layer 19 is disposed as shown in FIG. 12, whereby the image quality can be further improved. The sustain discharge is not generated between the bus electrodes 5A and 6A of the display cells adjacent to each other. Light generation intensity by the sustain discharge between the bus electrodes 5A and 6A is very low, and less contributes display brightness.

Typically, the phosphor layer 15 has almost white color, so that the surrounding visible light 17 is reflected by the phosphor layer 15 and is returned to the display surface side. Under the conditions that the plasma display device is practically used, some surrounding visible light may exist. The light reflected by the PDP 10B is combined with the light produced by the preliminary discharge and becomes the background brightness. Accordingly, suppressing the reflected light is also effective for improving the image. The light-shielding layer 19 shown in FIG. 12 covers not only the preliminary discharge area but also the area where the sustain discharge is not generated, and decreases the reflected light by the phosphor layer 15. The light-shielding layer 19 is preferably a black low reflection layer to further decrease the reflected light.

Now referring to FIG. 13, the first driving method of the plasma display devices in the first and second embodiments. FIG. 13 shows a priming electrode driving waveform Wp applied to the priming electrode 16, a sustain electrode driving waveform Wu applied to the sustain electrode 6, scanning electrode driving waveforms Ws1, Ws2, Wsm respectively applied to each scanning electrode 5, and a data electrode driving waveform Wd applied to the data electrode. One SF is constituted by a preliminary discharge period T1, a writing discharge period T2, a sustain discharge period T3 and an erase discharge period T4 similar to the prior art.

During the preliminary discharge period Ti, the potential of the priming electrode 16 is decreased to the GND level and the preliminary discharge pulse Pp that slowly increase the potential is applied to the scanning electrode 5 to generate the discharge over the area between the priming electrode 16 and the bus electrode 5A of the scanning electrode 5 in each display cell. Then, the potential of the priming electrode 16 is increased to the sustain voltage Vs level, and the preliminary discharge erase pulse Ppe is applied to the scanning electrode 5 to decrease the potential of the scanning electrode 5 gradually so as to generate the erase discharge. The erase discharge is generated to erase the wall charges accumulated by the preliminary discharge pluses Pp. The erase herein means that not only all wall charges are erased, but also the wall charges are controlled so that the subsequent writing discharge and the sustain discharge are smoothly conducted. The potential of the sustain electrode 6 is set to the Vs level so that a potential difference between the potentials of the sustain electrode 6 and the priming electrode 16 does not become significantly large and no discharge is generated between the electrodes.

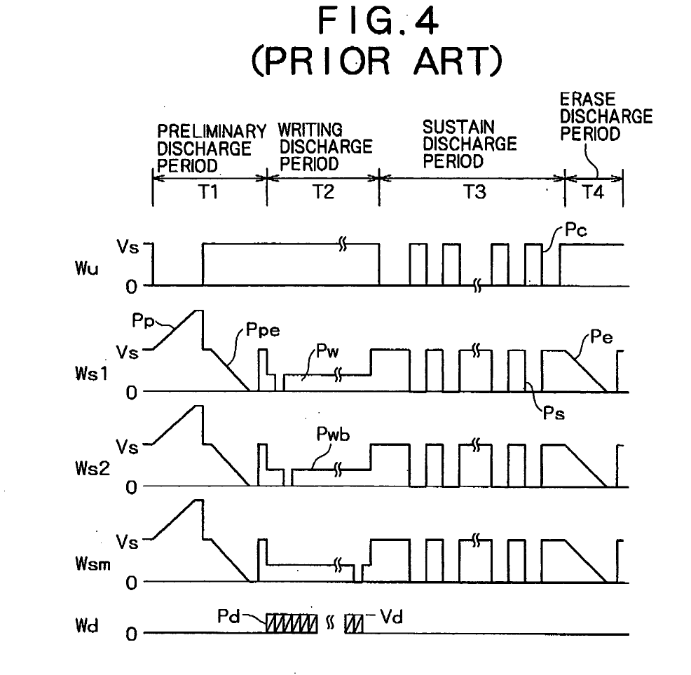

During the wiring discharge period T2, the driving pulses Wu, Ws1, Ws2, . . . , Wsm, Wd are the same as explained in the prior art shown in FIG. 4, and their descriptions are not repeated. The potential of the priming electrode 16 from the writing discharge period T2 to the erase discharge period T4 is set to the sustain discharge voltage Vs level. During the writing discharge period T2, the discharge between the priming electrode 16 and the data electrode 12 can be avoided even if the data pulse Pd is applied, as long as the potential of the priming electrode 16 is at least set to the potential level of the scanning base pulse Pwb or more. Also, the discharge between the priming electrode 16 and the sustain electrode 6 is avoided. During the sustain discharge period T3 and the erase discharge period T4, the potential difference between the priming electrode 16 and the scanning electrode 5 or the sustain electrode 6 is the sustain voltage Vs level at most. Accordingly, no discharge is generated in the priming electrode 16 where no wall charges that induces the sustain discharge is formed.

Consequently, as long as the potential of the priming electrode 16 is kept at the sustain voltage Vs level during the writing discharge period T2 and the erase discharge period T4, the priming electrode 16 does not affect, and good operation can be assured.

FIGS. 14A to 14F are sectional views of the plasma display device showing actions with the discharge generation areas and the wall charge placement from the preliminary discharge period T1 to the erase discharge period T4 in the first driving method. FIG. 14A is a sectional view of the plasma display device when the preliminary discharge pulse Pp is applied. FIG. 14B is a sectional view of the plasma display device when the preliminary discharge erase pulse Ppe is applied. FIG. 14C is a sectional view of the plasma display device when the scanning pulse Pw and the data pulse Pd are applied. FIG. 14D is a sectional view of the plasma display device when the potential of the sustain electrode 6 is in GND level during the sustain discharge period T3 and the potential of the scanning electrode 5 is in the sustain voltage Vs level. FIG. 14E is a sectional view of the plasma display device when the potential of the sustain electrode 6 is in the sustain voltage Vs level during the sustain discharge period T3 and the potential of the scanning electrode 5 is in GND level. FIG. 14F is a sectional view of the plasma display device when the erase pulse Pe is applied. The wall charges 18 are formed after the discharge is generated in each period.

As shown in FIG. 14A, when the preliminary discharge pulse Pp is applied, the preliminary discharge is generated between the priming electrode 16 and the bus electrode 5A, positive wall charges are accumulated on the priming electrode 16, and negative wall charges are accumulated on the bus electrode 5A. Depending on the types of the priming pulse voltage, the discharge may be generated between the bus electrode 5A and the data electrode 12. FIG. 14A shows such case. The wall charges accumulated on the scanning electrode 5, the sustain electrode 6 and the data electrode 12 other than the wall charges accumulated on the area of the data electrode 12 which is under the bus electrode 5A are formed not by the preliminary discharge but by the erase discharge.

As shown in FIG. 14B, when the preliminary discharge erase pulse Ppe is applied, the erase discharge is generated between the priming electrode 16 and the bus electrode 5A to decrease the wall charges on the priming electrode 16 and the bus electrode 5A.

As shown in FIG. 14C, when the scanning pulse Pw and the data pulse Pd are applied, the discharge is generated between the scanning electrode 5 and the data electrode 12, and the discharge is also generated between the scanning electrode 5 and the sustain electrode 6, induced by the discharge between the scanning electrode 5 and the data electrode 12. Depending on the polarity of the pulse applied, positive wall charges are formed on the scanning electrode 5, and negative wall charges are formed on the sustain electrode 6 and the data electrode 12.

As shown in FIG. 14D, when the potential of the sustain electrode 6 is set to GND level and the potential of the scanning electrode 5 is set to the Vs level in the sustain discharge period T3, the sustain discharge is generated between the scanning electrode 5 and the sustain electrode 6 to accumulate negative wall charges on the scanning electrode 5 and positive wall charges on the sustain electrode 6. The potential of the data electrode 12 is in the GND level, which is the lowest potential in the used voltages. The negative wall charges formed upon the writing discharge disappeared while the sustain discharge is generated. The positive wall charges are accumulated instead.

As shown in FIG. 14H, when the potential of the sustain electrode 6 is set to the Vs level and the potential of the scanning electrode 5 is set to the GND level, the positive wall charges are accumulated on the scanning electrode 5 and the negative wall charges are accumulated on the sustain electrode 6 by the sustain discharge with the inverse potential relative to the sustain discharge shown in FIG. 14D. The actions shown in FIGS. 14D and 14E are repeated until the desired brightness is obtained. Lastly, the sustain discharge is finished at the state shown in FIG. 14D.

As shown in FIG. 14F, when the erase pulse Pe is applied, the erase discharge is generated between the scanning electrode 5 and the sustain electrode 6, and the negative wall charges on the scanning electrode 5 and the positive wall charges on the sustain electrode 6 are decreased.

As described in the first and second embodiments and as shown in FIGS. 14A and 14B, since the space S exists between the bus electrode 5A and the scanning electrode 5 in the area facing to the discharge space, the discharge is generated between the priming electrode 16 and the bus electrode 5A upon the preliminary discharge and the erase discharge. Such status depends on the gas filled, the space distance between the bus electrode 5A and the scanning electrode 5, the voltage applied and the driving voltage waveforms. Depending on the conditions, the discharge may reach the scanning electrode 5 passing over the bus electrode area. Especially when the voltage applied is increased and the voltage that is steeply changed as the sustain pulse is applied, the phenomenon easy occurs. The following measures are taken.

It is desirable that the spreading of the preliminary discharge be inhibited as low as possible. Xn the case of the preliminary discharge pulse Pp and the preliminary discharge erase pulse Ppe as shown in FIG. 13, the voltages that are changed slowly are applied. They have a function to inhibit the spreading of the discharge, thereby effectively limiting the preliminary discharge between the priming electrode 16 and the bus electrode 5A. By the present inventor's experiments, it was found that a change in the voltages of the preliminary discharge pulse Pp and the preliminary discharge erase pulse Ppe is preferably 10 V/μs (microsecond) or less, and more preferably 5 V/μs or less for providing extremely stable effects.

On the other hand, the sustain discharge is preferably spread as great as possible in order to provide the desired brightness. A large area of the fluorescent material is excited to take up a large quantity of visible light. The sustain discharge is started from the space between the scanning electrode 5 and the sustain electrode 6, and is spread to outside along the electrodes. In the PDPs 10A and 10B in the first and second embodiments, since the space S exits between the scanning electrode 5 and the bus electrode 5A, the discharge is not easily spread to the bus electrode 5A. However, the sustain pulse Pc applies the voltage that is steeply changed. By optimizing the space distance and the gas filled, the sustain discharge can be spread to the bus electrode 5A.

By using the driving waveforms shown in FIG. 13 in the PDPs 10A and 10B in the first and second embodiments, the effects of the preliminary discharge are kept, a large quantity of the light can be produced by the sustain discharge, and a small quantity of light can be produced by the preliminary discharge, resulting in excellent image quality. By the present inventor's experiments, it was found that the space between the scanning electrode 5 and the bus electrode 55A in the area facing to the discharge space is preferably 30 to 150 μm for achieving the aforementioned properties. Although the potential of the priming electrode 16 is set to the sustain voltage Vs level during the sustain discharge period T3 to the erase discharge period T4, the present invention is not limited to those embodiments. For example, the potential having the same waveforms of the scanning electrode 5 adjacent to the priming electrode 16 may be applied to the priming electrode 16. An electrostatic capacitance, i.e., a load, of the sustain pulse Pc applied to the scanning electrode 5 also exist between the scanning electrode 5 and the sustain electrode 6, between the scanning electrode 5 and the data electrode 12 and also between the scanning electrode 5 and the priming electrode 16. If the load becomes great, the sustain pulse Pc is repeatedly applied, whereby power for charging and discharging the electrostatic capacitance may be excessive consequently, when the same waveforms of the scanning electrode 5 are applied to the priming electrode 16, it is not required to charge and discharge the electrostatic capacitance between the scanning electrode 5 and the priming electrode 16, thereby advantageously decreasing the power consumption. It is also effective to be the priming electrode 16 in the float state. The priming electrode 16 is electrostatically coupled to the scanning electrode 5 adjacent, and the potential of the priming electrode 16 is changed as the potential of the scanning electrode 5 is changed, whereby the power consumption for charging and discharging between the scanning electrodes 5 and the priming electrode 16 can be reduced.

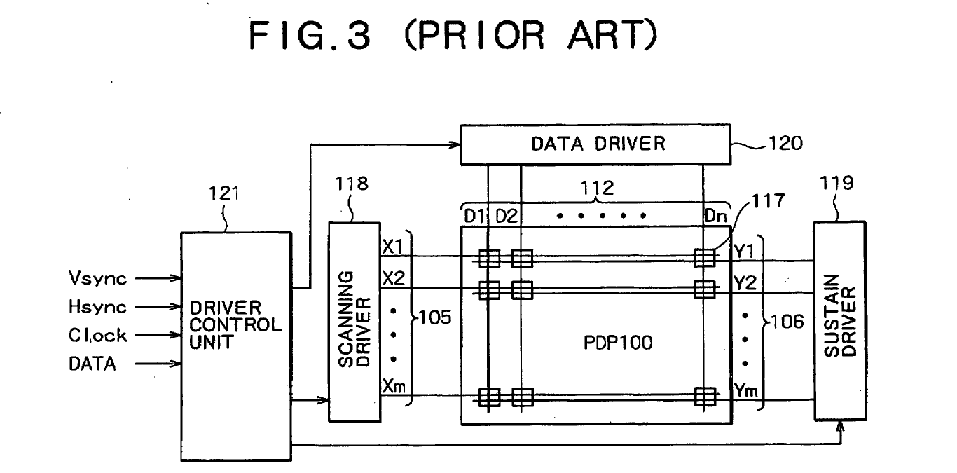

FIG. 15 a block diagram showing a schematic structure of the plasma display device having the driving circuit for achieving the driving waveforms shown in FIG. 13. The plasma display device in this embodiment has a structure different from the conventional plasma display device shown in FIG. 3 in that a priming driver 48 is added. The PDP 10B is a display panel having display cells 43 disposed in a matrix on intersections of m rows×n columns. The PDP 10B comprises as row electrodes scanning electrodes 5 (X1, X2, . . . , Xm) and sustain electrodes 6 (Y1, Y2, . . . , Ym) that are disposed parallel each other, and as column electrodes data electrodes 12 (D1, D2, . . . , Dn) that disposed orthogonal to the scanning electrodes 5 and the sustain electrodes 6. A scanning electrode driving waveform produced on a scanning driver 44 is applied to the scanning electrode 5. A sustain electrode driving waveform produced on a sustain driver 45 is applied to the sustain electrode 6. A data electrode driving waveform produced on a data driver 46 is applied to the data electrode 12. A driver control circuit 47 outputs a signal for controlling the priming driver 48. The priming driver 48 provides a driving waveform that is common to all priming electrodes 16. Control signals of respective drivers 44 to 46 are produced on the driver control circuit 47 based on a basic signal (Vsync (vertical synchronizing signal), Hsync (horizontal synchronizing signal), Clock (clock signal) and DATA (data signal)).

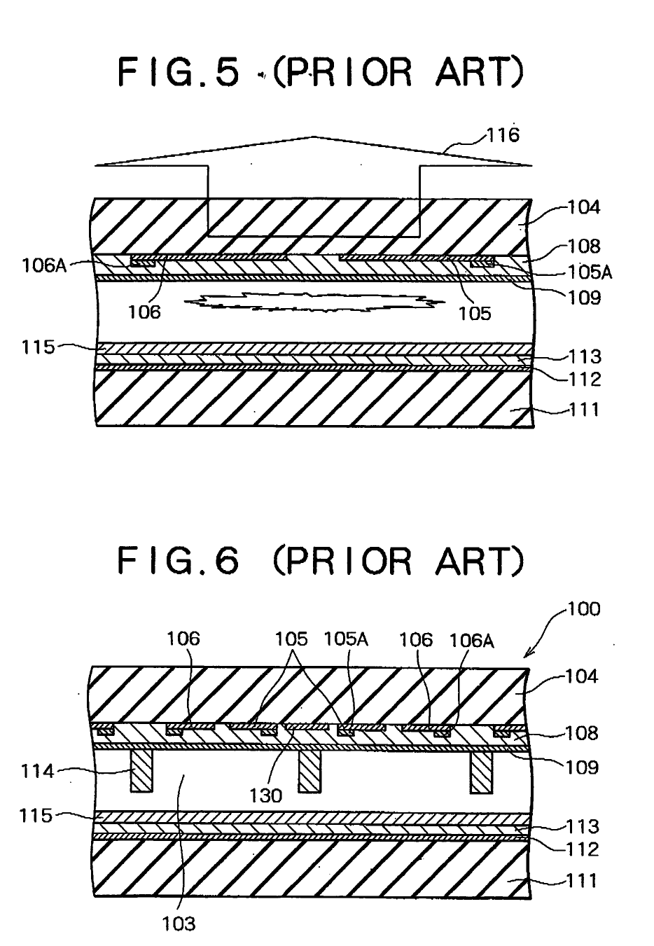

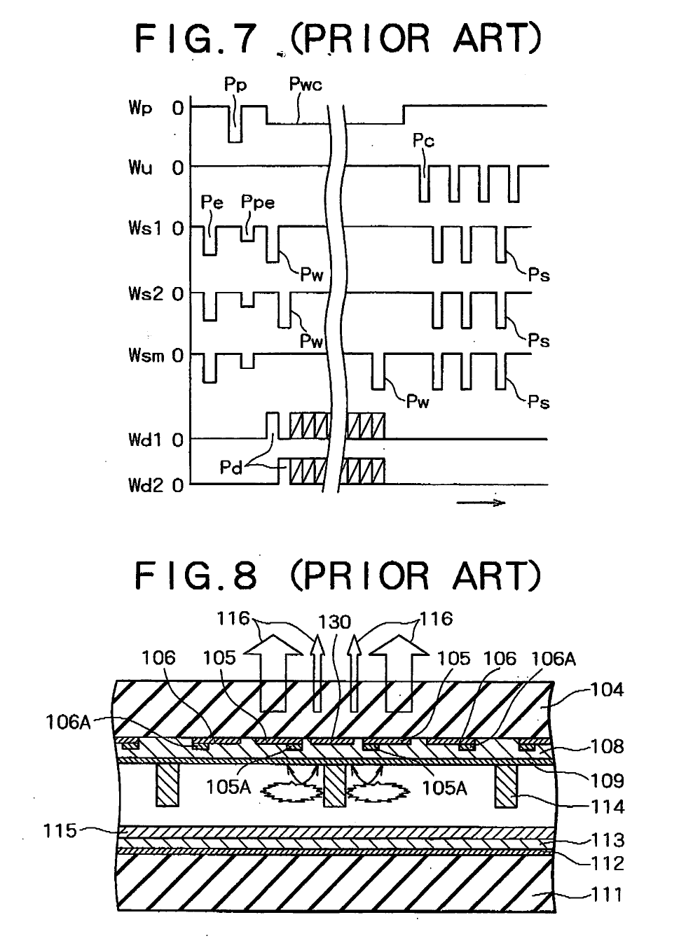

Referring to FIG. 16, the second driving method of the plasma display devices in the first and second embodiments will be described. The driving waveform of the second driving method shown in FIG. 16 is different in the potential of the priming electrode 16 in the writing discharge period T2 from that of the first driving method shown in FIG. 13. Also, in the second driving method, a priming bias pulse Pb is applied during the whole period of the writing discharge period T2. Other driving waveforms are the same as shown in FIG. 5, and the descriptions are not repeated. By the priming bias pulse Pb, the potential of the priming electrode 16 becomes higher than that of the sustain voltage Vs level during the writing discharge period T2. When the scanning pulse Pw is applied to the scanning electrode 5, i.e., the potential of the scanning electrode 5 is at GND level, the potential of the priming electrode 16 exceeds a discharge start voltage between the priming electrode 16 and the scanning electrode 5. When the scanning pulse Pw is not applied to the scanning electrode 5, i.e., the potential of the scanning electrode 5 is at the scanning base pulse Pwb level, the potential of the priming electrode 16 does not exceed a discharge start voltage between the priming electrode 16 and the scanning electrode 5.

The second preliminary discharge is generated between the priming electrode 16 and the bus electrode 5A of the scanning electrode 5 regardless of presence or absence of the data pulse Pd, every time the scanning pulse Pw is applied to the scanning electrodes 5. FIGS. 17A to 17Y are sectional views of the plasma display device showing actions with the discharge generation areas and the wall charge displacement from the preliminary discharge period T1 to the erase discharge period T4. FIG. 17A is a sectional view of the plasma display device when the preliminary discharge pulse Pp is applied. FIG. 17B is a sectional view of the plasma display device when the preliminary discharge erase pulse Ppe is applied. FIG. 17C is a sectional view of the plasma display device when the scanning pulse Pw and the data pulse Pd are applied. FIG. 17D is a sectional view of the plasma display device when the potential of the sustain electrode 6 is in GND level and the potential of the scanning electrode 5 is in the sustain voltage Vs level during the sustain discharge period T3. FIG. 17E is a sectional view of the plasma display device when the potential of the sustain electrode 6 is in the sustain voltage Vs level and the potential of the scanning electrode 5 is in GND level during the sustain discharge period T3. FIG. 17F is a sectional view of the plasma display device when the erase pulse Pe is applied. The wall charges 18 shown are formed after the discharge is generated in each period.

Each action shown in FIGS. 17A, 17B, 17D, 17E and 17F corresponds to and is basically similar to each action shown in FIGS. 14A, 14B, 14D, 14E and 14F. Therefore, the descriptions are not repeated. As shown in FIG. 17C, when the scanning pulse Pw and the data pulse Pd are applied, the second preliminary discharge is generated between the priming electrode 16 and the bus electrode 5A regardless of presence or absence of the data pulse Pd. Since the data pulse Pd is also applied, as the second preliminary discharge is generated, the discharge is also generated between the scanning electrode 5 and the data electrode 12, and then the discharge is generated between the scanning electrode 5 and the sustain electrode 6. Depending on the polarity of the pulse applied, negative wall charges are formed on the priming electrode 16, positive wall charges are formed on the scanning electrode 5, and negative wall charges are formed on the sustain electrode 6 and the data electrode 12. By the driving waveforms shown in FIG. 13, the preliminary discharge is generated only during the preliminary discharge period T1. Accordingly, activity of the display cells upon the writing discharge is similar to that of the prior art.

However, by the second driving waveforms shown in FIG. 16, the second preliminary discharge is generated every time the scanning pulse Pw is applied. Accordingly, the preliminary discharge always exists immediately before the writing discharge is generated, whereby the writing discharge is performed under an extremely high active state in every scanning line.

As the activity becomes high, the discharge lag time upon the writing is significantly decreased. In the second driving waveforms, the preliminary discharge time in each SF is increased as compared with the cases of the driving waveforms shown in FIG. 13 and the prior art. However, the second driving waveforms are applied to the PDPs 10A and 10B in the first and second embodiments, whereby the light produced by the preliminary discharge can be significantly decreased.

Thus, the similar advantages can be provided by this embodiment similar to the first embodiment.

In addition, according to this embodiment, the writing discharge can be performed with extremely high activity. Thus, the discharge lag time upon the writing is significantly decreased.

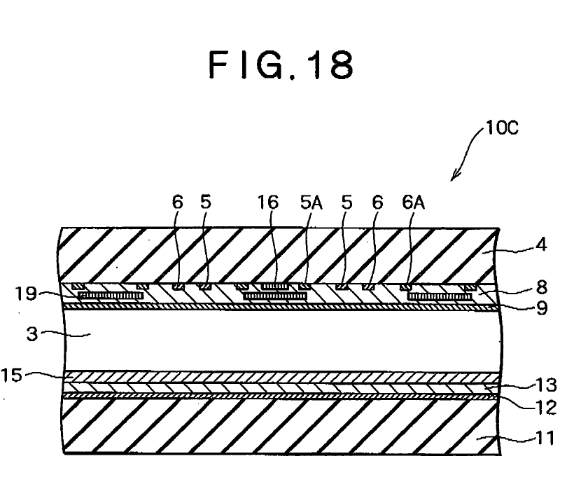

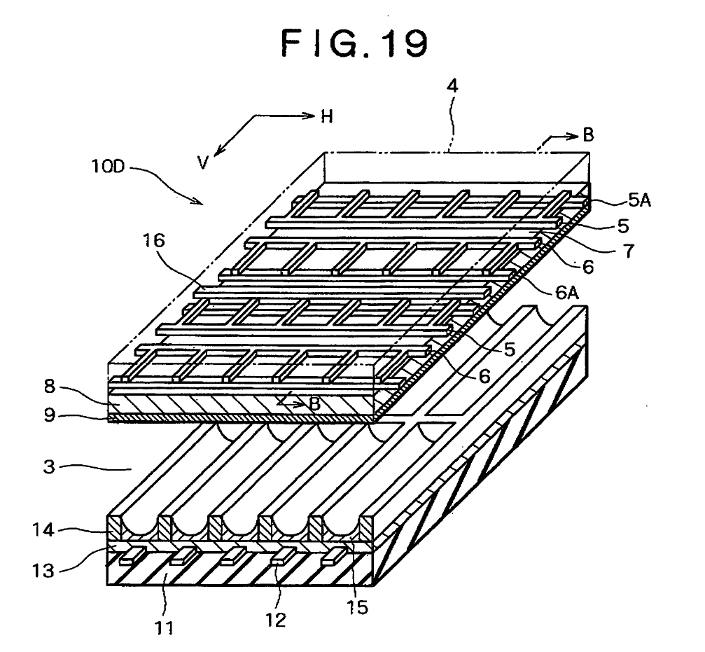

A third embodiment of the present invention will be described. FIG. 18 is a sectional view showing a schematic structure of a PDP constituting a main part of a plasma display device according to a third embodiment of the present invention. The PDP constituting the main part of the plasma display device in this embodiment has a structure different from the second embodiment in that the scanning electrodes and the sustain electrodes are disposed alternatively in the display cells so that the scanning electrodes in adjacent scanning lines are adjacent and the sustain electrodes in adjacent scanning lines are adjacent.

As shown in FIG. 18, in a PDP 10C constituting a main part of a plasma display device according to this embodiment, the scanning electrodes 5 and sustain electrodes 6 in the display cells are disposed alternatively so that the scanning electrodes 5 in adjacent scanning lines are adjacent and the sustain electrodes 6 in adjacent scanning lines are adjacent. The common priming electrode 16 is disposed between the bus electrodes 5A for the scanning electrodes in the adjacent scanning lines. The light-shielding layer 19 is disposed and covers between the adjacent bus electrodes 5A and between the adjacent bus electrodes 6A.

By disposing the scanning electrodes 5 and the sustain electrodes 6 as described above, it is possible to decrease an electrostatic capacitance that becomes a load when the sustain discharge pulse is applied. This is because the electrostatic capacitance is not required to be charged and discharged since the same voltage waveform is applied to the adjacent electrodes between the adjacent cells according to the third embodiment, although the electrostatic capacitance between the scanning electrode 5 and the sustain electrode 6 between adjacent cells becomes the load in the PDPs 10A and 10B according to the first and second embodiments.

Thus, the similar advantages can be provided by this embodiment similar to the second embodiment.

In addition, according to this embodiment, it is possible to decrease an electrostatic capacitance that becomes a load when the sustain discharge pulse is applied.

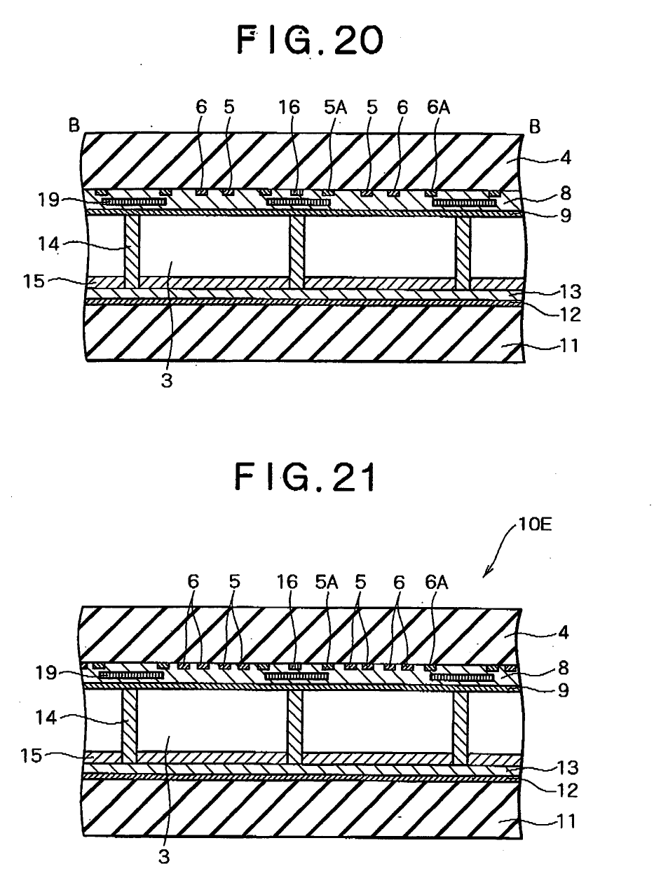

A fourth embodiment of the present invention will be described. FIG. 19 is a sectional view showing a schematic structure of a PDP constituting a main part of a plasma display device according to a fourth embodiment of the present invention. FIG. 20 is a B-B cross sectional view of FIG. 19. The PDP constituting the main part of the plasma display device in this embodiment has a structure different from the third embodiment in that the partition walls are disposed not only in the column direction but also in the row direction.

As shown in FIGS. 19 and 20, in a PDP 10D constituting a main part of a plasma display device according to this embodiment, partition walls 14 are disposed both in the column direction H and row direction V, and are in a lattice-like shape F.

By using the partitions 14, spaces between the scanning electrodes 5 including the bus electrodes 5A for the adjacent cells, and spaces between the sustain electrodes 6 including the bus electrodes 6A for the adjacent cells can be decreased to widen the sustain discharge area. If the spaces are excessively decreased in no partition walls 14 in the row (horizontal) direction H, space charges produced by discharging in the adjacent display cell are diffused and entered into the display cell and change the wall charges, which may induce erroneous discharge. The partition walls 14 in the row direction H prevent the space charges from diffusing, and no interference (erroneous discharge) caused by the adjacent cells is produced even if the spaces are decreased. Accordingly, good operation can be assured, and the PDP having higher sustaining discharge brightness than that of the PDP in the third embodiment can be provided.

Thus, the similar advantages can be provided by this embodiment similar to the third embodiment.

In addition, according to this embodiment, the sustain discharge area can be widen, thereby providing the PDP having high sustain discharge brightness.

A fifth embodiment of the present invention will be described. FIG. 21 is a sectional view showing a schematic structure of a PDP constituting a main part of a plasma display device according to a fifth embodiment of the present invention. The PDP constituting the main part of the plasma display device in this embodiment has a structure different from the fourth embodiment in that the electrodes are disposed intermediate the spaces.

As shown in FIG. 21, in a PDP 10E constituting a main part of a plasma display device according to this embodiment, the scanning electrodes 5 and the sustain electrodes 6 are disposed intermediate the spaces as dissimilar to the fourth embodiment.

As the sustain discharge area is widen in the fourth embodiment, the spaces between the scanning electrode 5 and the bus electrode 5A, and the space between the sustain electrode 6 and the bus electrode 6A that are faced to the discharge space can be increased. Although the discharge can be generated by selecting the gas filled, the voltage applied and the driving voltage waveforms for passing over the spaces, it becomes difficult when the spaces are too wide, as described above. It is effective to keep the optimal spaces, as the sustain discharge area is increased. Depending on the display cell size, it is effective that the electrodes are disposed intermediate the spaces as described in this embodiment.

Even if the preliminary discharge is passed over and spread the space between the bus electrode 5A and the scanning electrode 5 facing to the discharge space, the preliminary discharge is stopped at the next space to decrease the light produced by the preliminary discharge. The first driving waveforms shown in FIG. 5 or the second driving waveform shown in FIG. 16 can be applied to the PDPs 10C to 10E in the third to fifth embodiments to provide the displays.

Thus, the similar advantages can be provided by this embodiment similar to the fourth embodiment.

In addition, according to this embodiment, the sustain discharge area can be widen corresponding to the display cell size.

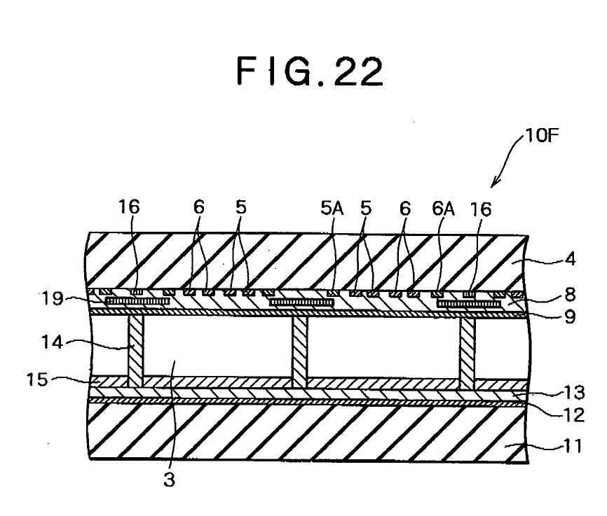

A sixth embodiment of the present invention will be described. FIG. 22 is a sectional view showing a schematic structure of a PDP constituting a main part of a plasma display device according to a sixth embodiment of the present invention. The PDP constituting the main part of the plasma display device in this embodiment has a structure different from the fifth embodiment in that the priming electrode is disposed between the sustain electrodes.

As shown in FIG. 22, in a PDP 10F constituting a main part of a plasma display device according to this embodiment, the priming electrode 16 is disposed between the sustain electrodes 6 including the bus electrodes 6A.

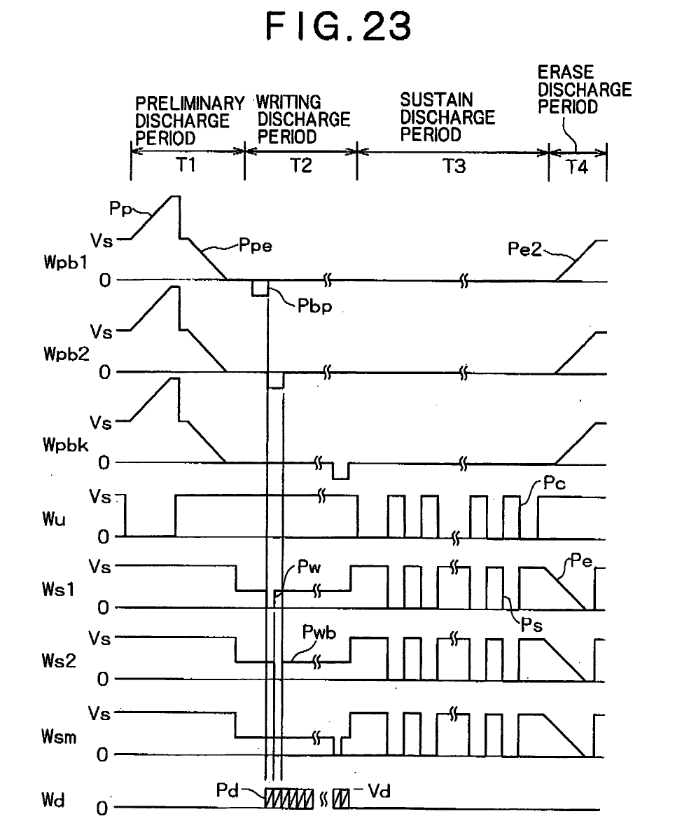

Now referring to FIG. 23, the first driving method of the plasma display devices in this embodiment. FIG. 23 shows priming electrode driving waveforms Wpb1, Wpb2, Wbpk applied to the priming electrode 16, a sustain electrode driving waveform Wu applied to the sustain electrode 6, scanning electrode driving waveforms Ws1, Ws2, Wsm respectively applied to each scanning electrode 5, and a data electrode driving waveform Wd applied to the data electrode 12. One SF is constituted by a preliminary discharge period T1, a writing discharge period T2, a sustain discharge period T3 and an erase discharge period T4.

During the preliminary discharge period T1, the potential of the sustain electrode 6 is decreased to the GND level and the preliminary discharge pulse Pp, the potential of which is slowly increased, is applied to each priming electrode 16 to generate the discharge over the area between the priming electrode 16 and the bus electrode 6A of the sustain electrode 6 in each display cell. Then, the potential of the sustain electrode 6 is increased to the sustain voltage Vs level, and the preliminary discharge erase pulse Ppe is applied to the priming electrode 16 to decrease slowly their potentials, whereby the erase discharge is generated. The erase discharge is generated to erase the wall charges accumulated by the preliminary discharge pluses Pp. The erase herein means that not only all wall charges are erased, but also the wall charges are controlled so that the subsequent writing discharge and the sustain discharge are smoothly conducted. The potential of the scanning electrode 5 is set to the Vs level so that a potential difference between the potentials of the scanning electrode 5 and the priming electrode 16 does not become significantly large and no discharge is generated between the electrodes.

During the writing discharge period T2, the voltage waveforms of Wu, Ws1, Ws2, . . . , Wsm, Wd are the same as explained in the prior art shown in FIG. 4, and the descriptions of the respective driving pulses are not repeated. During the writing discharge period T2, a priming scanning pulse Pbp that has a negative potential relative to the GND potential is sequentially applied to the priming electrode 16. The voltage of the priming scanning pulse Pbp is set to be a value so that the potential difference between the priming electrode 16 and the sustain electrode 6 including the bus electrode 6A is greater than the discharge start voltage between the priming electrode 16 and the bus electrode 6A of the sustain electrode 6. Since the priming electrode 16 is common to the display cells having the adjacent scanning electrodes 5, the numbers of the priming electrode 16 is half of the numbers of the scanning lines. The second preliminary discharge is generated in the display cells on the scanning lines including the priming electrode 16 that is applied to the priming scanning pulse Pbp regardless of presence or absence of the data pulse Pd. In the driving waveforms, the second preliminary discharge always exists immediately before the writing discharge, whereby the writing discharge is performed under an extremely high active state in every scanning line. As the activity becomes high, the discharge lag time upon the writing is significantly decreased.

During the sustain discharge period T3, while a sustain discharge pulse Pc is repeatedly applied to the scanning electrode 5 and the sustain electrode 6, the potential of the priming electrode 16 is kept at GND level. However, the potential of the priming electrode 16 is not limited thereto, and may have the same voltage waveforms as the sustain electrodes 5 or may be in the float state.

Finally, during the erase discharge period T4, an erase pulse Pe is applied to the scanning electrodes 5 to erase the wall charges accumulated on the scanning electrode 5 and the sustain electrodes 6. A priming scanning discharge erase pulse Pe2 is applied to the priming electrode 16. The priming scanning discharge erase pulse Pe2 has a waveform that the potential is slowly increased, and erases the wall charges on the priming electrode 16 produced by the second preliminary discharge applied by the priming scanning pulse Pbp. The erase herein means that not only all wall charges are erased, but also the wall charges are controlled so that the subsequent writing discharge and the sustain discharge are smoothly conducted.

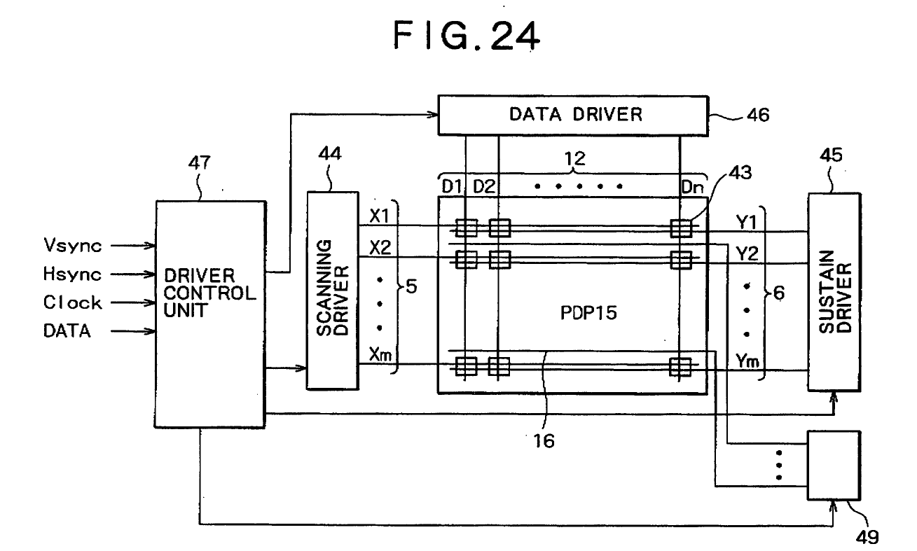

FIG. 24 is a block diagram showing a schematic structure of the plasma display device having a driving circuit with the driving waveforms of FIG. 23. The plasma display device in this embodiment has a structure different from that shown in FIG. 15 in that the priming driver 49 is added. The driver control circuit 47 outputs a signal for controlling the priming driver 49. The priming driver 49 outputs a voltage waveform for driving the priming electrode.

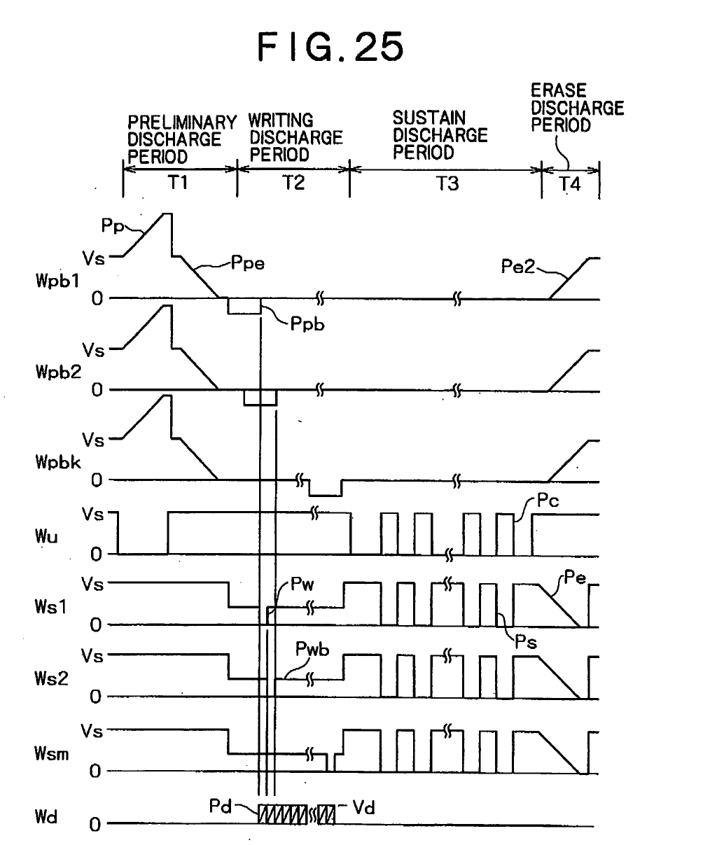

Referring to FIG. 25, the second driving method of the plasma display devices in the sixth embodiment. The driving waveforms shown in FIG. 25 is different from those used in the first driving method shown in FIG. 23 in that the priming scanning pulse Pbp is applied before the scanning pulse Pw is generated, and the priming scanning pulse Pbp are overlapped with the priming scanning pulse Pbp for the former scanning lines to be sequentially applied. To decrease the second preliminary discharge strength, one measure is to decrease the amplitude of the priming scanning pulse Pbp, whereby the voltage applied upon the preliminary discharge is decreased. However, if the applied voltage is decreased, the discharge lag time upon the writing discharge generation is increased. If the voltage applied time is short, the preliminary discharge may not be produced within the range. As shown in FIG. 25, when a time for applying the priming scanning pulse Pbp is increased, such a problem can be solved and stable second preliminary discharge can be provided. The time for applying the priming scanning pulse Pbp from the earliest time of generating the second preliminary discharge to the time for applying the scanning pulse Pw can be increased to the degree that the activity is not less than the desired level. Although it depends, for example, on the gas filled, the time is preferably 100 μs or less, and more preferably 30 μs or less by the present inventor's experiments in order to perform the writing discharge with extremely high activity.

When the priming scanning pulse Pbp is widen, it is effective to slowly increase the potential difference between the bus electrode 6A of the sustain electrode 6 and the priming electrode 16 so that the voltage waveforms have the slowly decreasing voltage. In this case, even if the amplitude of the priming scanning pulse Pbp is large, the second preliminary discharge strength can be decreased as in the case of the discharge with the preliminary pulse Pp as described above.

When the width of the priming scanning pulse Pbp is increased, whole priming electrodes 16 may be divided into a plurality of groups to which a plurality of priming electrodes 16 belong and the priming scanning pulse may be applied to all of the priming electrodes 16 belonging to the same group at the same timing. The writing discharge may be continuously performed at the plural scanning lines belongs to the same group of the priming electrodes 16, after the second preliminary discharge is generated with the priming scanning pulse Pbp. In this case, the numbers of the output lines in the priming driver 49 shown in FIG. 24 can be decreased, whereby the priming driver circuit 49 can be simplified.

The aforementioned driving method shown in FIGS. 23 and 25 is described using the PDP 10F in the sixth embodiment shown in FIG. 22. However, the structure of the PDP is not limited thereto. As long as the priming electrode 16 is disposed adjacent to the bus electrode 6A of the sustain electrode 6, the driving method can be used therefor.

Thus, the similar advantages can be provided by this embodiment similar to the fifth embodiment.

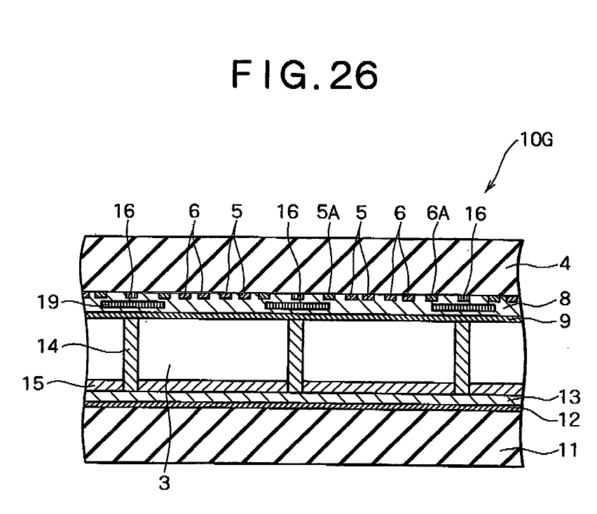

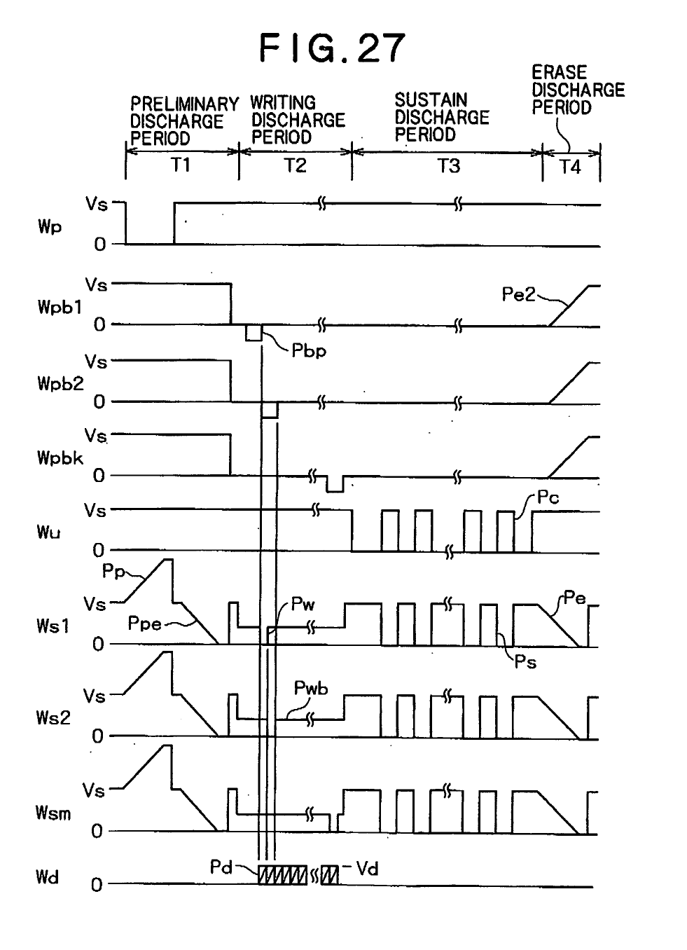

A seventh embodiment of the present invention will be described. FIG. 26 is a sectional view showing a schematic structure of a PDP constituting a main part of a plasma display device according to a seventh embodiment of the present invention. FIG. 27 shows driving wave-forms used in a method of driving the plasma display device of the seventh embodiment. The PDP constituting the main part of the plasma display-device in this embodiment has a structure different from the sixth embodiment in that the priming electrode is also disposed between the bus electrodes of the scanning electrodes in the adjacent display cells.

As shown in FIG. 26, in a PDP 10G constituting a main part of a plasma display device according to this embodiment, the priming electrode 16 is also disposed between the bus electrodes 5A of the scanning electrodes 5 in the adjacent display cells as dissimilar to the sixth embodiment. In the PDP 10G of this embodiment, two types of the priming electrodes 16 disposed between the sustain electrodes 6 and between the scanning electrodes 5 respectively, can be used independently.

Now referring to FIG. 27, the driving method of the plasma display devices in the seventh embodiment will be described. FIG. 27 shows a priming electrode driving waveform Wp applied to the priming electrode 16 between the scanning electrodes 5, priming electrode driving waveforms Wpb1, Wpb2, . . . , Wbpk respectively applied to each priming electrode 16 between the sustain electrodes 6, a sustain electrode driving waveform Wu applied to the sustain electrode 6, scanning electrode driving waveforms Ws1, Ws2, Wsm respectively applied to each scanning electrode 5, and a data electrode driving waveform Wd applied to the data electrode 12. One SF is constituted by a preliminary discharge period T1, a writing discharge period T2, a sustain discharge period T3 and an erase discharge period T4.

During the preliminary discharge period T1, the potential of the priming electrode 16 between the scanning electrodes 5 is decreased to the GND level (see the voltage waveform WP) and the preliminary discharge pulse Pp that slowly increases the potential is applied to the scanning electrodes 5 to generate the discharge over the area formed by the priming electrode 16 and the bus electrode 5A of the scanning electrodes 5 in each display cell. Then, the potential of the priming electrode 16 is increased to the sustain voltage Vs level, and the preliminary discharge erase pulse Ppe is applied to the scanning electrodes 5 to decrease slowly their potentials, whereby the erase 15 discharge is generated. The erase discharge is generated to erase the wall charges accumulated by the preliminary discharge pluses. The erase herein means that not only all wall charges are erased, but also the wall charges are controlled so that the subsequent writing discharge and the sustain discharge are smoothly conducted. The potentials of the priming electrode 16 between the sustain electrodes 6 and the potentials of the sustain electrodes 6 are set to the Vs level.

During the writing discharge period T2, the voltage waveforms of Wu, Ws1, Ws2, . . . , Wsm, Wd which are the same as those explained in the prior art are applied to sequentially generate the writing discharge. The potential of the priming electrode 16 between the scanning electrodes 5 is set to the Vs level. The priming scanning pulse Pbp that has a negative potential relative to the GND potential is sequentially applied to the priming electrode 16 between the sustain electrodes 6 (see the voltage waveforms Wpb1, Wpb2, . . . , Wpbk). The voltage of the priming scanning pulse Pbp is set to be a value so that the potential difference between the priming electrode 16 and the sustain electrode 6 including the bus electrode 6A is greater than the discharge start voltage between the priming electrode 16 and the bus electrode 6A of the sustain electrode 6. The second preliminary discharge is generated in the display cells on the scanning lines including the priming electrode 16 that is applied to the priming scanning pulse Pbp regardless of presence or absence of the data pulse Pd. In the driving waveforms, the second preliminary discharge always exists immediately before the writing discharge is generated, whereby the writing discharge is performed under a extremely high active state in every scanning line. As the activity becomes high, the discharge lag time upon the writing is significantly decreased.

During the sustain discharge period T3, while a sustain discharge pulse Pc is repeatedly applied to the scanning electrode 5 and the sustain electrode 6, the potential of the priming electrode 16 between the scanning electrodes 5 is kept at Vs level and the potential of the priming electrode 16 between the sustain electrodes 6 is kept at GND level. However, the potential of the priming electrode 16 is not limited thereto. The priming electrode 16 between the scanning electrodes 5 may have the same voltage waveforms as the scanning electrodes 5 or may be in the float state. The priming electrode 16 between the sustain electrodes 6 may have the same voltage waveforms as the sustain electrodes 6 or may be in the float state.

Finally, during the erase discharge period T4, erase pulse Pe is applied to the scanning electrodes 5 to erase the wall charges accumulated on the scanning electrode 5 and the sustain electrodes 6. A priming scanning discharge erase pulse Pe2 is applied to the priming electrode 16 between the sustain electrodes 6. The priming scanning discharge erase pulse Pe2 has a waveform that the potential is slowly increased, and erases the wall charges on the priming electrode 16 produced by the second preliminary discharge applied by the priming scanning pulse Pbp. The erase herein means that not only all wall charges are erased, but also the wall charges are controlled so that the subsequent writing discharge and the sustain discharge are smoothly conducted.

The priming scanning pulse Pbp is not limited to those shown in FIG. 27. The priming scanning pulse Pbp may be applied before the scanning pulse Pw is generated, be overlapped with the priming scanning pulse Pbp for the former scanning lines and be sequentially applied. Also, the priming scanning pulse Pbp may have the potential waveforms that are slowly decreased. Whole priming electrodes 16 may be divided into a plurality of groups to which a plurality of priming electrodes 16 belong and the priming scanning pulse Pbp may be applied to the priming electrodes 16 belonging to the same group at the same timing. The writing discharge may be continuously performed at the scanning lines in each of the groups of the priming electrodes 16, after the second preliminary discharge with the priming scanning pulse Pbp is generated. By the priming bias pulse Pb, the potential of the priming electrode 16 between the scanning electrodes 5 becomes higher than Vs during the writing discharge period T2. The third preliminary discharge may be generated between the priming electrode 16 and the bus electrodes 5A of the scanning electrode 5 every time the scanning pulse Pw are applied to the scanning electrodes 5, regardless of presence or absence of the data pulse Pd.

Thus, the similar advantages can be provided by this embodiment similar to the sixth embodiment.

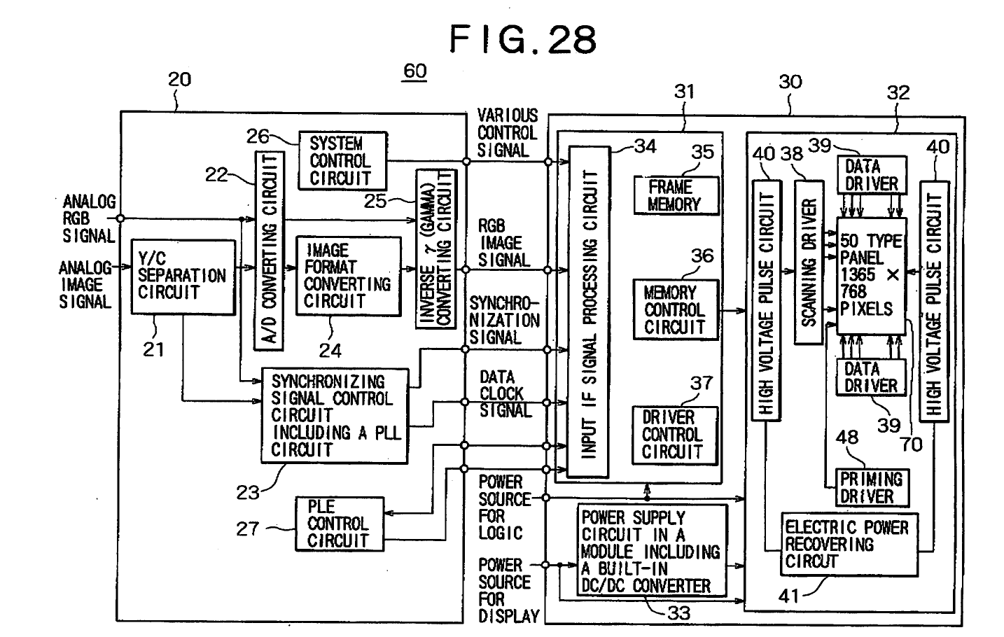

An eighth embodiment of the present invention will be described. FIG. 28 is a block diagram showing a schematic structure of the plasma display device of the eighth embodiment. The plasma display device in this embodiment is constituted using the PDPs in the first to seventh embodiments.

As shown in FIG. 28, the plasma display device 60 in this embodiment comprises a module structure, namely an analog interface (IF) 20 and a PDP module 30.

The analog IF 20 comprises an Y/C separation circuit 21 having a chroma-decoder, an A/D converting circuit 22, a synchronizing signal control circuit 23 including a PLL circuit, an image format converting circuit 24, an inverse γ (gamma) converting circuit 25, a system control circuit 26, and a PLE control circuit 27.

The analog IF 20 converts an analog image signal received into a digital image signal, and feeds the digital image signal into the PDP module 30. For example, after the analog image signal transmitted from a television tuner is decomposed in each RGB color in the Y/C separation circuit 21, and is converted into the digital signal in the A/D converting circuit 22. Thereafter, when a pixel configuration of the PDP module 30 is different from that of the image signal, required image format conversion is performed at the image format converting circuit 24. Properties of image brightness are linearly proportional to the PDP input signal. In general, the image signal is corrected (γ converted) in advance corresponding to the properties of CRT. After the image signal is A/D converted in the A/D converting circuit 22, the image signal is subjected to inverse y conversion in the inverse γ converting circuit 25 to restore the original linear properties and to produce a digital image signal. The digital image signal is outputted to the PDP module 30 as an RGB image signal.

Since the analog image signal does not contain A/D converting sampling clock and data clock signals, the PLL circuit built in the synchronizing signal control circuit 23 produces the sampling clock and data clock signals based on a horizontal synchronizing signal that is provided simultaneously as the analog image signal, and outputs them to the PDP module 30. The PLE control circuit 27 in the analog IF 20 control the brightness. Specifically, when an average brightness level is less than the predetermined value, the PLE control circuit 27 increases the display brightness. When the average brightness level exceeds the predetermined value, the PLE control circuit 27 decreases the display brightness.

The system control circuit 26 outputs various control signals to the PDP module 30. The PDP module 30 comprises a digital signal processing and control circuit 31, a panel 32, and a power supply circuit 33 in a module including a built-in DC/DC converter. The digital signal processing and control circuit 31 comprises an input IF signal processing circuit 34, a frame memory 35, a memory control circuit 36, and a driver control circuit 37.

For example, the average brightness level of the image signal inputted to the input IF signal processing circuit 34 is calculated by an input signal average brightness level arithmetic circuit (not shown) in the input IF signal processing circuit 34, and is, for example, outputted as a 5 bit data. The PLE control circuit 27 sets a PLE control data depending on the average brightness level, and inputs it to a brightness control circuit (not shown) in the input IF signal processing circuit 34.

The digital signal processing and control circuit 31 processes these signals in the input IF signal processing circuit 34, and then transmits a control signal to the panel 32. At the same time, the memory control circuit 36 and the driver control circuit 37 transmits a memory control signal and a drive control signal to the panel 32.

The panel 32 comprises a PDP 70, a scanning driver 38 driving the scanning electrodes, a data driver 39 driving the data electrodes, a high voltage pulse circuit 40 feeding the pulse voltage to the PDP 70 and the scanning driver 38, an electric power recovering circuit 41 recovering a surplus electricity from the high voltage pulse circuit 40, and a priming driver 48 that feeds a common driving waveform to all priming electrodes 16 of the PDP 70.

The PDP 70 has, for example, 1365×768 pixels. In the PDP 70, the predetermined pixels are turned on or off by controlling the scanning electrodes with the scanning driver 38, and by controlling the data electrodes with the data driver 39, thereby displaying an image.

A power source for logic feeds electric power for logic to the digital signal processing and control circuit 31 and the panel 32. A power source for display feeds DC power to a power supply circuit 33 in the module. The power supply circuit 33 converts the voltage of the DC power to the predetermined voltage, and then feeds it to the panel 32.

A method of producing the plasma display device 60 in this embodiment will be described.

The PDP 70, the scanning driver 38, the data driver 39, the high voltage pulse circuit 40 and the electric power recovering circuit 41 are disposed on a substrate to form the panel 32. The digital signal processing and control circuit 31 is provided separately.

Thus-formed panel 32, the digital signal processing and control circuit 31 and the power supply circuit 33 in a module are assembled as a module to form the PDP module 30. The analog IF 20 is provided separately from the PDP module 30.

Thus, after the PDP module 30 and the analog IF 20 are manufactured separately, both are electrically connected to complete the plasma display device 60 as shown in FIG. 28.

By modularizing the plasma display device 60, the plasma display device 60 can be produced independently and separately from other components for constituting the plasma display device 60. For example, when the plasma display device 60 becomes out of order, only the PDP module 30 may be replaced. Thus, repair can be simplified and conducted in a shorter time.

While the embodiments of the present invention have been described referring to the drawings, the present invention is not to be unduly limited to those illustrative embodiments set forth hereinabove and it will be understood by those skilled in the art that various modifications and alternations in designs and the like may be made without departing from the spirit and scope of the present invention. For example, although the priming discharge is generated between the priming electrode and the bus electrode of the scanning electrode in the embodiments, the priming discharge may be generated between the priming electrode and the bus electrode of the sustain electrode.

1. A plasma display device, comprising:
a plurality of pairs of surface discharge electrodes, said pair of the surface discharge electrode having a scanning electrode and a sustain electrode that are extended in a predetermined direction and disposed parallel to each other via a discharge gap, and said scanning electrode and said sustain electrode each having a transparent electrode facing to the discharge gap, a bus electrode having lower light transmittance than that of the transparent electrode facing to the discharge gap via the transparent electrode, and a connection part electrically connecting a gap between the bus electrode and the transparent electrode; and
priming electrodes disposed between said pairs of said surface discharge electrodes,
wherein a surface discharge generated between the transparent electrodes of the scanning electrode and the sustain electrode extends to the bus electrodes of the scanning electrode and the sustain electrode over the gap, and a preliminary discharge generated between the priming electrode and the bus electrode of the scanning electrode or the bus electrode of the sustain electrode does not extend to the transparent electrodes of the scanning electrode and the sustain electrode over the gap adjacent to the bus electrode.

2. A plasma display device according to claim 11 further comprising a light-shielding layer that covers at least the gap between the transparent electrode and the bus electrode.

3. A plasma display device according to claim 1, wherein the light-shielding layer covers at least a gap between the priming electrode and the transparent electrode of the scanning electrode or the sustain electrode that is paired with the priming electrode.

4. A method of driving a plasma display device comprising a plurality of pairs of surface discharge electrodes, said pair of the surface discharge electrode having a scanning electrode and a sustain electrode that are extended in a predetermined direction and disposed parallel to each other via a discharge gap; and priming electrodes disposed between said pairs of said surface discharge electrodes, comprising the steps of:
first preliminary discharging simultaneously entire display cells between the priming electrode and the scanning electrode or the sustain electrode adjacent to the priming electrode, and
second preliminary discharging sequentially the entire display cells after said first preliminary discharging.

5. A method of driving a plasma display device according to claim 4, wherein the scanning electrode and the sustain electrode each has a transparent electrode facing to the discharge gap and a bus electrode having lower light transmittance than that of the transparent electrode facing to the discharge gap via the transparent electrode, each gap between the bus electrode and the transparent electrode being electrically connected by a connection part
wherein a surface discharging generated between the transparent electrodes of the scanning electrode and the sustain electrode extends to the bus electrodes of the scanning electrode and the sustain electrode over the gap, and said first or a second preliminary discharging generated between the priming electrode and the bus electrode of the transparent electrode or the scanning electrode does not extend to the transparent electrode of the transparent electrode or the scanning electrode over the gap adjacent to the bus electrode.

6. A method of driving a plasma display device according to claim 4, said second preliminary discharging is performed between the priming electrode and the scanning electrode or the sustain electrode adjacent to the priming electrode that is not subjected to the first preliminary discharging.

7. A method of driving a plasma display device according to claim 4, said first preliminary discharging is performed at a driving pulse with a gradually changing potential.

8. A method of driving a plasma display device according to claim 4, said second preliminary discharging is sequentially discharging in each scanning line.

9. A method of driving a plasma display device according to claim 4, said second preliminary discharging is performed by applying a priming bias pulse to said priming electrode.
